(19) United States
(12) Patent Application Publication
(10) Pub. No.: US 2026/0340354 A1
(43) Pub. Date: Oct. 29, 2026

(54) Efficient Generation of Multimodal Sequences Using Between-Frame and Within-Frame Machine-Learned Models

(71) Applicant: Google LLC, Mountain View, CA (US)

(72) Inventors: Brian Victor McWilliams, Zürich (CH); Emmanuel René Jacques Orsini, Paris (FR); Zalán Borsos, Zürich (CH); Alexandru Tudor, Zürich (CH); Damien Vincent, Zürich (CH); Marco Tagliasacchi, Lugano (CH)

(21) Appl. No.: 19/110,749

(22) PCT Filed: Dec. 9, 2024
(86) PCT No.: PCT/US2024/059142

§ 371 Date: Mar. 11, 2025

Related U.S. Application Data
(60) Provisional application No. 63/610,674, filed on Dec. 15, 2023.

(51) Int. Cl. G06N 3/0475

(52) U.S. Cl. CPC G06N 3/0475

(57) ABSTRACT

A multimodal sequence can be generated on a frame-by-frame basis, where each frame can be associated with a multi-token portion of the sequence. A first machine-learned model (a “frame model”) can generate a frame token representative of an entire frame (e.g. a time frame), and one or more additional models (“depth models”) can generate individual tokens associated with the frame based on the frame token.

### CROSS-REFERENCE TO RELATED APPLICATIONS

The present application is based upon and claims the right of priority under 35 U.S.C. § 371 to International Application No. PCT/US2024/059142 filed on Dec. 9, 2024, which claims the filing benefit of U.S. Provisional Patent Application No. 63/610,674, filed on Dec. 15, 2023. Applicant claims priority to and the benefit of each of such applications and incorporate all such applications herein by reference in its entirety.

### FIELD

The present disclosure relates generally to machine learning processes and machine-learned devices and systems. More particularly, the present disclosure relates to systems and methods for efficiently generating multimodal sequences using two or more machine-learned models in combination.

### BACKGROUND

A computer can receive input(s). The computer can execute instructions to process the input(s) to generate output(s) using a parameterized model. The computer can obtain feedback on its performance in generating the outputs with the model. The computer can generate feedback by evaluating its performance. The computer can receive feedback from an external source. The computer can update parameters of the model based on the feedback to improve its performance. In this manner, the computer can iteratively “learn” to generate the desired outputs. The resulting model is often referred to as a machine-learned model.

### SUMMARY

Aspects and advantages of embodiments of the present disclosure will be set forth in part in the following description, or can be learned from the description, or can be learned through practice of the embodiments.

A system of one or more computers can be configured to perform particular operations or actions by virtue of having software, firmware, hardware, or a combination of them installed on the system that in operation causes or cause the system to perform the actions. One or more computer programs can be configured to perform particular operations or actions by virtue of including instructions that, when executed by data processing apparatus, cause the apparatus to perform the actions.

One general aspect includes a computer-implemented method for efficiently generating multimodal sequenced outputs using a multiscale machine-learned architecture. The method includes generating, using a first machine-learned sequence processing model, a first frame token associated with a first frame. The computer-implemented method also includes generating, using a second machine-learned sequence processing model and based on the first frame token, a first frame-aligned token associated with the first frame and characterized by a first mode. The method also includes generating, using at least one of the second machine-learned sequence processing model and a third machine-learned sequence processing model, and based on at least one of the first frame token and the first frame-aligned token, a second frame-aligned token associated with the first frame and characterized by a second mode, where the second mode is different from the first mode. Other embodiments of this aspect include corresponding computer systems, apparatus, and computer programs recorded on one or more computer storage devices, each configured to perform the actions of the methods.

Another general aspect includes a computing system that may include one or more processors and one or more non-transitory computer-readable media storing instructions that are executable by the one or more processors to cause the computing system to perform one or more operations. The operations include generating, using a first machine-learned sequence processing model, a first frame token associated with a first frame. The operations include generating, using a second machine-learned sequence processing model and based on the first frame token, a first frame-aligned token associated with the first frame and characterized by a first mode. The operations include generating, using at least one of the second machine-learned sequence processing model and a third machine-learned sequence processing model, and based on the first frame token, a second frame-aligned token associated with the first frame and characterized by a second mode, where the second mode is different from the first mode. Other embodiments of this aspect include corresponding computer systems, apparatus, and computer programs recorded on one or more computer storage devices, each configured to perform the actions of the methods.

Another general aspect includes one or more non-transitory computer-readable media storing instructions that are executable by one or more computing systems to perform one or more operations. The one or more non-transitory computer-readable media store instructions for performing operations. The operations include generating, using a first machine-learned sequence processing model, a first frame token associated with a first frame. The operations include generating, using a second machine-learned sequence processing model and based on the first frame token, a first frame-aligned token associated with the first frame and characterized by a first mode. The operations include generating, using at least one of the second machine-learned sequence processing model and a third machine-learned sequence processing model, and based on the first frame token, a second frame-aligned token associated with the first frame and characterized by a second mode, where the second mode is different from the first mode. Other embodiments of this aspect include corresponding computer systems, apparatus, and computer programs recorded on one or more computer storage devices, each configured to perform the actions of the methods.

Other aspects of the present disclosure are directed to various systems, apparatuses, non-transitory computer-readable media, user interfaces, and electronic devices.

These and other features, aspects, and advantages of various embodiments of the present disclosure will become better understood with reference to the following description and appended claims. The accompanying drawings, which are incorporated in and constitute a part of this specification, illustrate example embodiments of the present disclosure and, together with the description, serve to explain the related principles.

### BRIEF DESCRIPTION OF THE DRAWINGS

FIG. 1 is a block diagram of an example implementation of an example system according to the present disclosure.

FIG. 2A is a block diagram of an example implementation of an example system according to the present disclosure.

FIG. 2B is a block diagram of an example implementation of an example system according to the present disclosure.

FIG. 3 is a table of results of an example test according to the present disclosure.

FIG. 4 is a flowchart diagram of an example method according to the present disclosure.

FIG. 5 is a flowchart diagram of an example method according to the present disclosure.

FIG. 6 is a flow chart diagram illustrating an example method for training a machine-learned model according to example implementations of aspects of the present disclosure;

FIG. 7 is a block diagram of an example processing flow for using machine-learned model(s) to process input(s) to generate output(s) according to example implementations of aspects of the present disclosure;

FIG. 8 is a block diagram of an example sequence processing model according to example implementations of aspects of the present disclosure;

FIG. 9 is a block diagram of an example technique for populating an example input sequence for processing by a sequence processing model according to example implementations of aspects of the present disclosure;

FIG. 10 is a block diagram of an example model development platform according to example implementations of aspects of the present disclosure;

FIG. 11 is a block diagram of an example training workflow for training a machine-learned model according to example implementations of aspects of the present disclosure;

FIG. 12 is a block diagram of an inference system for operating one or more machine-learned model(s) to perform inference according to example implementations of aspects of the present disclosure;

FIG. 13 is a block diagram of an example networked computing system according to example implementations of aspects of the present disclosure;

FIG. 14 is a block diagram of an example computing device according to example implementations of aspects of the present disclosure; and

FIG. 15 is a block diagram of an example computing device according to example implementations of aspects of the present disclosure.

### DETAILED DESCRIPTION

Generally, the present disclosure is directed to the efficient generation of multimodal sequences using two or more machine-learned models in combination. Multimodal sequences can include sequences having tokens of multiple modes (e.g. audio, text, image, semantic tokens). Tokens from multiple modes can be associated together as a single “frame” (e.g. one or more audio tokens and one or more image tokens associated with a single time frame), and some modes may use multiple tokens of that mode per frame (e.g. audio tokens in a residual vector quantization format). Methods for generating such sequences can include autoregressive generation (e.g. using a transformer), which can generate a next token based on a computation that takes into account every token generated previously (e.g. an attention mechanism). However, for multimodal sequences having many tokens per frame, the computational cost of autoregression can in some instances be high (e.g. self-attention cost proportional to T²*Q², wherein T is a number of frames generated and Q is a number of tokens generated per frame). Techniques for non-autoregressive generation of multimodal sequences can be faster but can in some instances produce lower quality outputs than autoregressive generation. Advantageously, example implementations of the present disclosure can perform autoregressive generation at reduced computational cost by using a first machine-learned model to generate a frame token for each sequence frame and using a second machine-learned model to generate individual tokens within each frame. In this manner, for instance, systems and methods of the present disclosure can generate multimodal sequences of similar or better quality than existing autoregressive methods, at a lower computational cost.

Example implementations of the present disclosure can include a frame model configured to generate a frame token for each frame of an output sequence. A frame can be a portion of an output sequence such as, for example, a portion associated with a particular time frame (e.g. video output of 30 frames per second, etc.). A frame token can be a single token representative of multiple output tokens associated with the frame, such as an average-pooled value or a machine-learned embedding value associated with a combination of multiple output tokens. Advantageously, the frame model can generate frame tokens autoregressively based on previously generated frame tokens at a lower computational cost (e.g. self-attention cost proportional to T², where T is a number of frame tokens generated) than autoregressively generating each token within the frame (T²*Q², as noted above).

Example implementations of the present disclosure can include one or more output depth models configured to take a frame token as input and generate one or more output tokens based on the frame token, wherein each output token is associated with the same frame of the output sequence. In some instances, an output depth model can generate tokens autoregressively within a frame but can ignore any previously generated token that is not associated with the frame. Advantageously, this can enable the output depth models to autoregressively generate output tokens at a lower computational cost (e.g. self-attention cost proportional to Q² for each frame, or T*Q² for an entire output sequence) than autoregressively generating tokens based on all previously generated output tokens (T²*Q²). Additionally, the output depth models can advantageously be configured to have a lower computational cost than the frame model (e.g. by having a smaller number of parameters than the frame model) and a lower computational cost than prior models for autoregressively generating frame-based multimodal output sequences. In this manner, for instance, the output depth models can generate a high-quality sequence of output tokens within a frame, at a reduced computational cost compared to previous methods.

In some instances, multiple output depth models may be used to generate tokens of multiple modes (e.g. audio, text, image, semantic tokens, etc.). In some instances, a multimodal output depth model may be configured to generate tokens of multiple modes using one model (e.g. audio and semantic, audio and text, etc.).

In some example implementations, one of the output depth models can be a model configured to autoregressively generate a plurality of audio tokens for each frame. In some instances, the audio tokens can be residual vector quantization (RVQ) tokens. RVQ tokens can be tokens configured so that an earlier-generated token (e.g. a first token generated) approximates a desired output (e.g. audio waveform) at a coarse granularity, and a later-generated token (e.g. a second token generated) approximates a difference between the earlier-generated token and a desired output, at a finer granularity. As a simplified illustrative example, a system using residual quantization to approximate the number 3.71386 might generate a first token equal to 4.0; a second token equal to −0.3, such that the sum of the first and second tokens is 3.7; a third token equal to 0.01, and so on.

Example implementations of the present disclosure can include an output frame generator, which can combine one or more tokens generated by the depth model(s) to generate one or more output frames. For example, in some instances, the output frames can include an audio output frame, which can be computed by additively combining a plurality of RVQ audio tokens.

Example implementations of the present disclosure can include an input depth model configured to generate input frame tokens for use by the frame model. This input frame token can be based on tokens generated by the depth model(s). For example, a frame model can generate a first frame token associated with a first frame; output depth model(s) can generate output tokens associated with the first frame based on the first frame token; and input depth model(s) can then generate an input frame token associated with the first frame, based on the output tokens generated by the output depth model(s). In this manner, for instance, a frame model can autoregressively generate later frame tokens based on input frame tokens representing output frames created by the output depth model, which in some instances may be similar to or different from a first frame token generated by the frame model and associated with the same frame.

In some instances, one or more input depth models can be configured to combine tokens of multiple modes into a single input frame token capturing information about multiple tokens of a single frame. For example, in some instances an input depth model can be a multimodal model configured to embed tokens from multiple modalities into a single input space before combining them into a single input frame token. In some instances, a plurality of output depth models can be used, and each respective output depth model can be associated with one or more respective modes. In some instances, a frame model and an output depth model can be jointly trained with an input depth model, such that the three models can operate on a shared embedding space.

In some instances, the output depth models can include both autoregressive and non-autoregressive models. For example, in instances where tokens are structured in an RVQ format, a first output token may have a larger impact on a final output quality than a second output token; a second output token may have a larger impact than a third; and so on. In such instances, a first N tokens per frame can be generated autoregressively to ensure high output quality, and tokens after the first N can be generated using faster methods. Advantageously, values for the variable N can be selected to maximize a tradeoff between output quality and computational cost, and different values of N can be selected for different applications associated with different tradeoffs.

Although the above paragraphs describe the output depth models, input depth models, and frame models as separate machine-learned models, the models can in some instances be jointly trained and can in some instances operate as a single unit without going outside the scope of the present disclosure. For example, in some instances a mixture of experts model or ensemble model can comprise a frame model, input depth models, and depth models.

Example implementations of the present disclosure achieve various technical effects and benefits. In some instances, systems and methods of the present disclosure can achieve better performance (e.g. generate output having a higher audio quality) than prior methods. In some instances, systems and methods of the present disclosure can achieve similar performance (e.g. similar audio quality) at a reduced computational cost (e.g. reduced electricity cost) compared to prior systems and methods.

In some example experiments, systems and methods of the present disclosure can be compared to prior methods for autoregressively generating audio outputs, along with prior fast methods for non-autoregressively generating audio outputs. In some instances, systems and methods of the present disclosure can generate audio associated with a lower word error rate, lower character error rate, and higher audio quality than prior autoregressive and non-autoregressive methods. Additionally, systems and methods of the present disclosure can achieve those results faster (e.g. at least twice as fast) and at reduced computational cost compared to prior autoregressive methods.

A technical effect of example implementations of the present disclosure is increased energy efficiency in performing operations using machine-learned models, thereby improving the functioning of computers implementing such models. For instance, example implementations can provide for more energy-efficient runtime execution or inference. In some scenarios, increased energy efficiency can provide for less energy to be used to perform a given task (e.g., less energy expended to maintain the model in memory, less energy expended to perform calculations within the model, etc.). In some scenarios, increased energy efficiency can provide for more task(s) to be completed for a given energy budget (e.g., a larger quantity of tasks, more complex tasks, the same task but with more accuracy or precision, etc.).

In another example aspect, example implementations can provide for more energy-efficient training operations or model updates. In some scenarios, increased energy efficiency can provide for less energy to be used to perform a given number of update iterations (e.g., less energy expended to maintain the model in memory, less energy expended to perform calculations within the model, such as computing gradients, backpropagating a loss, etc.). In some scenarios, increased energy efficiency can provide for more update iterations to be completed for a given energy budget (e.g., a larger quantity of iterations, etc.). In some scenarios, greater expressivity afforded by model architectures and training techniques of the present disclosure can provide for a given level of functionality to be obtained in fewer training iterations, thereby expending a smaller energy budget. In some scenarios, greater expressivity afforded by model architectures and training techniques of the present disclosure can provide for an extended level of functionality to be obtained in a given number of training iterations, thereby more efficiently using a given energy budget.

In this manner, for instance, the improved energy efficiency of example implementations of the present disclosure can reduce an amount of pollution or other waste associated with implementing machine-learned models and systems, thereby advancing the field of machine-learning and artificial intelligence as a whole. The amount of pollution can be reduced in toto (e.g., an absolute magnitude thereof) or on a normalized basis (e.g., energy per task, per model size, etc.). For example, an amount of CO₂ released (e.g., by a power source) in association with training and execution of machine-learned models can be reduced by implementing more energy-efficient training or inference operations. An amount of heat pollution in an environment (e.g., by the processors/storage locations) can be reduced by implementing more energy-efficient training or inference operations.

Various example implementations are described herein with respect to the accompanying Figures.

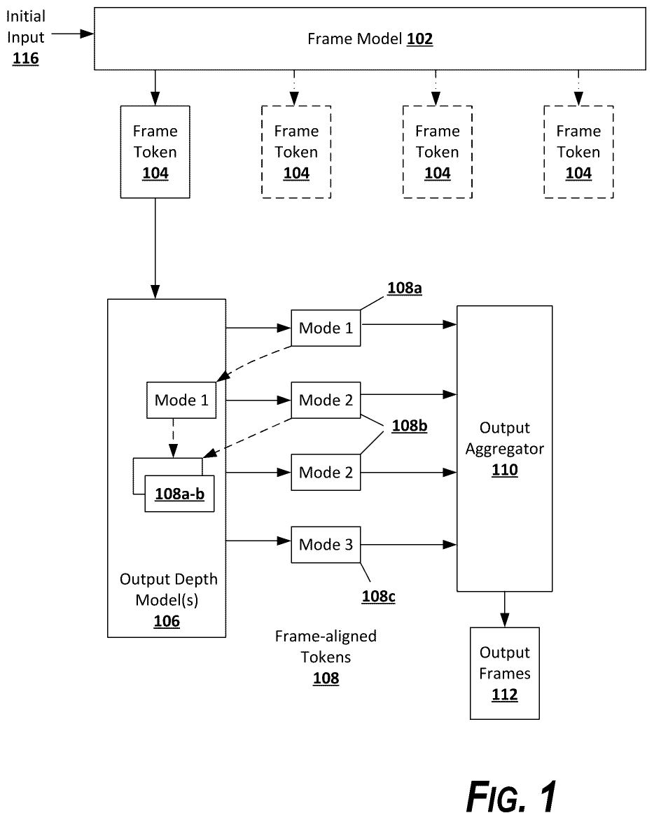

FIG. 1 is a block diagram of an example implementation of an example system according to the present disclosure. A frame model 102 can generate a sequence of frame tokens 104 based on an initial input 116, with each frame token 104 being associated with at least one frame (e.g. temporal frame) of a final output sequence. Based on each frame token 104, output depth model(s) 106 can generate a plurality of frame-aligned tokens 108, wherein each frame-aligned token 108 is characterized by a mode (e.g. audio, text, image, semantic modes, etc.). Frame-aligned tokens 108a can be characterized by a first mode; 108b a second mode; and 108c a third mode. An output aggregator 110 can combine two or more frame-aligned tokens 108 (e.g. 108b) to generate one or more output frames 112.

The frame model 102 can include one or more machine-learned models. The frame model 102 can include various model architectures. An example architecture for the frame model 102 can include a sequence processing model architecture (e.g. a transformer model). For example, the frame model 102 can be configured to receive an input sequence and generate an output sequence. For instance, the frame model 102 can be configured to generate an output sequence where elements of the output sequence are predicted based on elements of the input sequence. The frame model 102 can be configured to generate an output sequence where some elements of the output sequence are predicted based on previously generated elements of the output sequence, such as previously generated frame tokens 104. In some instances, the frame model 102 can use an attention mechanism (e.g. causal self-attention). In some instances, an attention cache of the frame model 102 can be configured to store information associated with previously generated frame tokens 104 (e.g. all frame tokens 104 previously generated for a particular input context).

The frame token 104 can be a token associated with one or more frames (e.g. temporal frames) of an output sequence. A frame can be a portion of an output sequence (e.g. a temporal portion) having a plurality of associated tokens. For example, in some instances, a frame can be a portion of an output sequence associated with a time period (e.g. 0.1 seconds, 0.01 seconds, etc.), and the frame can be associated with a plurality of tokens associated with that time period (e.g. images, text, and audio configured to be displayed together during the time period; semantic token indicative of a meaning associated with the output sequence during that time period; etc.). In other instances, a frame can be a portion of an output sequence defined in other ways (e.g. a percentage of an output sequence; a chunk of N output tokens, such as one output token for each of N modes; etc.).

In some instances, a frame token 104 can be representative of multiple frame-aligned tokens 108 associated with a frame. For example, in some instances, a frame token 104 can be representative of a desired or expected average pooling value of a plurality of frame-aligned tokens 108 associated with the frame. For example, after a plurality of frame-aligned tokens 108 are generated for a particular frame, an actual average pooling value can be computed by summing one or more values associated with the frame-aligned tokens 108 and dividing by a number of frame-aligned tokens 108. In some instances, a frame token 104 can be representative of an expected or desired average pooling value, and an output depth model 106 can be configured to generate pluralities of frame-aligned tokens 108 such that the actual average pooling value can approximate the desired or expected average pooling value. Similarly, in some instances a frame token 104 can be representative of a desired or expected machine-learned embedding value of a plurality of frame-aligned tokens 108 or a combined value computed from multiple machine-learned embeddings (e.g. average-pooled machine-learned embeddings). In some instances, a frame token 104 can correspond to a semantic token representative of a semantic meaning associated with a frame. In some instances, a frame token 104 can be associated with more than one frame (e.g. more than one temporal frame). In such instances, the frame token 104 can be representative of, for example, an expected or desired machine-learned embedding value of a plurality frame-aligned tokens 108 associated with more than one frame.

The output depth model(s) 106 can include one or more machine-learned models. The output depth model(s) 106 can include various model architectures. An example architecture for the output depth model(s) 106 can include a sequence processing model architecture (e.g. a transformer model, e.g. a decoder-only transformer model, multilayer perceptron configured to process a sequence, e.g. multilayer perceptron configured to operate autoregressively, etc.). For example, output depth model(s) 106 can be configured to receive an input sequence and generate an output sequence. For instance, the output depth model(s) 106 can be configured to generate an output sequence where elements of the output sequence are predicted based on elements of the input sequence. The output depth model(s) 106 can be configured to generate an output sequence where some elements of the output sequence are predicted based on previously generated elements of the output sequence. In some instances, the output depth model(s) 106 can be configured to predict some frame-aligned tokens 108 based on previously generated elements associated with the same frame, but without reference to previously generated elements associated with previous frames. In some instances, output depth model(s) 106 can use an attention mechanism (e.g. causal self-attention). In some instances, an attention cache of one or more output depth models 106 may be configured to store information associated with previously generated frame-aligned tokens 108 associated with a current frame. In some instances, an attention cache of the output depth models 106 may be configured to lack any information associated with frames other than a current frame (e.g. an attention cache of the output depth models 106 may be cleared each time a frame model 102 generates a new frame token 104). In some instances, a single frame token 104 may be associated with two or more frames; in such instances an attention cache of the output depth models 106 may be configured to store information associated with previously generated frame-aligned tokens 108 associated with a current frame token 104, including frame-aligned tokens 108 associated with a frame other than a current frame.

In some instances, an output depth model 106 can be a multilayer perceptron. In some instances, a multilayer perceptron can be configured to operate autoregressively. In some instances, a multilayer perceptron can be configured to generate a frame-aligned token 108 from an input based at least in part on a current frame token 104. In some instances, an input to a multilayer perceptron can comprise the current frame token 104 alone, or a machine-learned embedding of the frame token 104 alone. In other instances, an input to a multilayer perceptron output depth model 106 can be based on a current frame token 104 and one or more frame-aligned tokens 108 already generated with respect to a current frame or current frame token 104. In some instances, an input to a multilayer perceptron can comprise an average-pooled value or a summed embedding. For example, in some instances, a frame token 104 associated with a current frame and one or more frame-aligned tokens 108 associated with the current frame can be embedded in a shared machine-learned embedding space. In some instances, the embedded values can be subsequently combined (e.g., summed, average pooled, etc.).

In some instances, an output depth model 106 and frame model 102 can be configured to generate a token sequence such that an autoregressive factorization of the joint probability over a token sequence χis represented by the equation below. In the equation, T can be a number of frame tokens 104 generated. Q can be a number of frame-aligned tokens 108 associated with each frame token 104. A token x_{t,q} can be a qth token associated with a tth frame token 104, and a token zₜ can be a tth frame token.

$$p ( x ) = {\prod }_{t = 1}^{T} {\prod }_{q = 1}^{Q} p ( {x}_{t , q} \vert {x}_{t , < q} , {z}_{t} ) p ( {z}_{t} \vert {z}_{< t} ) .$$

In some instances, the output depth model(s) 106 can include a plurality of machine-learned models (e.g. configured for a plurality of specialized purposes). In some instances, the output depth model(s) 106 can include a first depth model configured to generate tokens characterized by a first mode (e.g. audio); a second depth model configured to generate tokens characterized by a second mode (e.g. text, image, semantic, etc.); a third depth model, and so on. In some instances, the output depth model(s) 106 can be a single machine-learned model (e.g. multimodal machine-learned model, e.g. configured to generate both audio and text).

In some instances, the output depth model(s) 106 can include one or more autoregressive machine-learned models and one or more non-autoregressive machine-learned models. For example, in some instances, an autoregressive depth model can be used for generating high-priority frame-aligned tokens 108 (e.g. tokens associated with a large impact on a final output quality), and a non-autoregressive depth model can be used for generating lower-priority frame-aligned tokens 108 (e.g. RVQ-structured tokens having a small impact on a final audio waveform output).

In some instances, the output depth model(s) 106 can include machine-learned models having a similar (e.g. same) or different architecture from the frame model 102. The output depth model(s) 106 can use one or more model components or model architectures used by the frame model 102. The output depth model(s) 106 can be entirely different from the frame model 102. In some instances, the output depth model(s) 106 can include one or more models having a number of parameters that is smaller (e.g. 5 times, 10 times, 20 times, 30 times, 50 times, 100 times smaller, etc.) than a number of parameters of the frame model 102. In some instances, the depth model(s) 106 can be characterized by a computing cost (e.g. inference cost, pretraining cost, fine-tuning cost, memory usage, etc.) that is lower than a computing cost of the frame model 102. In some instances, an architecture of an output depth model 106 (e.g. a number of parameters, etc.) or an architecture of a frame model 102 can be chosen based on a particular use case (e.g. a number of parameters can be selected to optimize a performance-speed tradeoff or performance-computing cost tradeoff associated with the use case).

The frame-aligned tokens 108 can include or be representative of any appropriate computer-readable data (e.g. text data, audio data, image data, semantic data, etc.). Each respective frame-aligned token 108 can be characterized by one or more modes 108a, 108b, 108c (e.g. text, audio, image, semantic, multimodal token, etc.). In some instances, the frame-aligned tokens 108 can include a plurality of tokens (e.g. same-mode tokens, e.g. audio tokens, image tokens, etc.) having a residual vector quantization (RVQ) structure. An RVQ structure can be a structure wherein each subsequently generated token for a frame and mode (after the first token generated for a frame and mode) can represent a residual value (e.g. a residual value remaining after one or more audio waveforms associated with previously generated tokens is subtracted from a final output audio waveform). In some instances, a plurality of RVQ-structured tokens can be configured such that a final output value for a frame can be computed by additively combining a plurality of respective output values associated with the plurality of respective RVQ-structured tokens.

In some instances, the frame-aligned tokens 108 can be associated with the entirety of exactly one frame. For example, in some instances, the frame can be a time frame, and the frame-aligned tokens 108 can be configured to correspond to a time period having the same length as the frame. For example, in some instances, the output depth models 106 and frame model 102 can be configured to output tokens associated with time periods of the same length. In other instances, a frame-aligned token 108 can be associated with more than one frame or can be associated with only a part of a frame. For example, in some instances where a frame is a temporal frame (e.g. one fiftieth of a second, etc.), some frame-aligned tokens 108 can be associated with more than one frame (e.g. a time period that spans more than one frame, e.g. a semantic token representing a word spoken in an audio clip, wherein an audio waveform associated with the word lasts for more than one frame; a text token associated with a captioning output, where the captioning output is configured to be displayed for more than one frame; etc.). In some implementations, a frame-aligned token 108 associated with multiple frames can be implemented by duplicating the frame-aligned token 108 multiple times (e.g. by generating the frame-aligned token 108 and associating it with more than one frame). In some implementations, a frame-aligned token 108 can be processed to better approximate a one-to-one token-to-frame correspondence (e.g. by computing a time-aligned token based on one or more non-time-aligned tokens, etc.). A person skilled in the art will recognize that other implementation details are possible.

The output aggregator 110 can be, for example, a computing system configured to accept one or more frame-aligned tokens 108 as input and generate one or more output frames 112 as output. For example, in some instances an output aggregator 110 can be configured to accept as input a plurality of RVQ-structured frame-aligned tokens 108 characterized by a mode (e.g. 108b), and generate as output a frame characterized by the mode (e.g. a frame of audio output, image output, etc.). In some instances, the output aggregator 110 can be configured generate output frames 112 by additively combining frame-aligned tokens 108 of the same mode (e.g. 108b). In other instances, the output aggregator can include a machine-learned model or other method for generating output frames 112 from frame-aligned tokens 108.

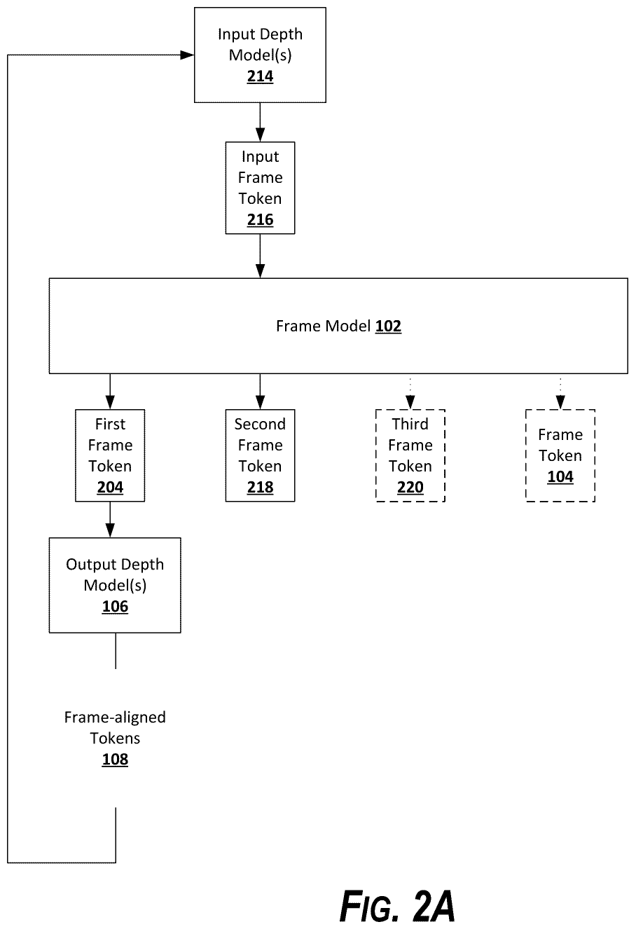

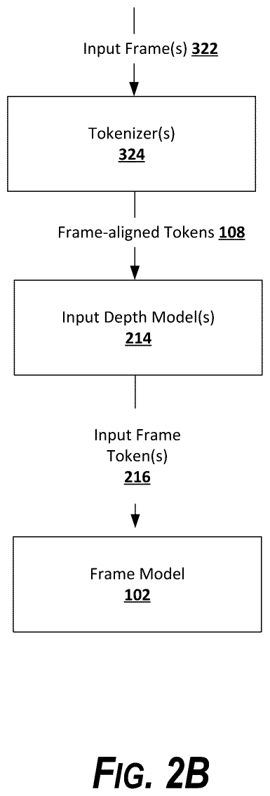

FIG. 1 depicts an initial input 116. The initial input can comprise any appropriate computer-readable data (e.g. audio, text, image, machine-learned token, etc.). In some instances, the initial input 116 can comprise an input context or input prompt (e.g. textual prompt). In some instances, an input context can comprise an RVQ matrix or flattened RVQ matrix. In some instances, an input context can comprise one or more input frames (e.g. video frames, audio frames, etc.). As an illustrative example, an input context can comprise a music clip or speech audio clip, and a frame model 102 can be configured to generate a musical continuation or speech continuation. In some instances, the initial input can comprise one or more frame tokens 104. In some instances, an initial input 116 comprising one or more frame tokens 104 can be generated from one or more input frames in a manner described with respect to FIG. 2B. Other methods of obtaining frame tokens 104 are possible (e.g. generated by a frame model 102, generated in a manner described with respect to FIG. 2A).

FIG. 2A is a block diagram of an example implementation of an example system according to the present disclosure. A frame model 102 can generate (e.g. based on an input context) a first frame token 204 associated with a first frame. Output depth model(s) 106 can generate frame-aligned tokens 108 associated with the first frame based on the first frame token 204. In some instances, the output depth model(s) 106 can be configured to generate a plurality of frame-aligned tokens 108 intended to approximate the first frame token 204 when combined by an input depth model 214. An input depth model 214 can generate an input frame token 216 based on the frame-aligned tokens 108. The frame model 102 can then generate a second frame token 218 based on the input frame token 216. This process can be repeated for additional tokens in a sequence. For instance, the frame model 102 can generate a third frame token 220 based on both the input frame token 216 and a second input frame token (not pictured) generated by the input depth model 214 based on frame-aligned tokens 108 associated with a second frame (not pictured).

The first frame token 204 can be, comprise, or be comprised by a frame token 104. In some instances, the frame model 102 can generate the first frame token 204 based on an input context (e.g. a text prompt, an audio clip comprising speech audio, an audio clip comprising music, etc.). In some instances, an input context can comprise an RVQ-structured input matrix. In some instances, the frame model 102 or another system can flatten an RVQ matrix before the frame model 102 generates the first frame token 204. The first frame token can be associated with a first frame (e.g. first temporal frame).

The input depth model(s) 214 can include one or more machine-learned models. The input depth model(s) 214 can include various model architectures. An example architecture for the input depth model(s) 214 can include a sequence processing model architecture (e.g. a transformer model). In some instances, the input depth model(s) 214 can be configured to receive an input sequence or plurality of input tokens and generate an output sequence or output token. In some instances, the input depth model(s) 214 can include two or more machine-learned models, with each model being associated with one or more modes (e.g. audio mode, text mode, image mode, semantic mode, etc.). In some instances, the input depth model(s) 214 can include one or more multi-modal machine-learned models capable of processing tokens of multiple modes. In some instances, the input depth model(s) 214 can be configured to embed one or more frame-aligned tokens 108 into a shared output space before combining the embeddings, e.g. via average pooling.

In some instances, the input depth model(s) 214 can be configured to generate one input frame token 216 based on an arbitrarily large number of interleaved tokens of multiple modalities (e.g. multiple tokens per modality, multiple modalities, multiple frames per frame token, etc). For example, an input chunk length can be determined for each modality (e.g. a number of tokens of that modality to be associated with a single input frame token 216). One or more input depth model(s) 214 and output depth model(s) 106 can then be configured to operate on chunks of that length. In some instances, chunk lengths associated with different modalities can have similar (e.g. same) sizes or different sizes. During training, handling chunks of different sizes can in some instances be implemented efficiently with packing. During sampling, chunk lengths can be determined dynamically based on one or more sampled token types (e.g. a mode of a sampled token, e.g. audio, text, image, semantic mode). In some instances, an attention cache of one or more depth models or input depth models can be configured to store information related to previously generated tokens associated with a current chunk. For example, if a chunk is associated with multiple frames, an attention cache can store information related to previously generated tokens associated with previous frames of a current chunk. In some instances, an attention cache of an output depth model 106 or input depth model 214 can be configured to clear away information related to previous chunks.

In some instances, the input depth model(s) 214 can have an architecture that is similar to or different from an architecture of one or more depth models 106. For example, in some instances, an architecture of the input depth model(s) 214 can be based on an architecture of an output depth model 106. For example, in some instances, an architecture of a depth model 106 can include an attention mechanism (e.g. causal self-attention), and an architecture of an input depth model 214 can be the same as an architecture of an output depth model 106 except that the attention mechanism can be replaced with a different attention mechanism (e.g. bidirectional self-attention). In some instances, an architecture of an input depth model 214 can be unrelated to an architecture of one or more output depth models 106. In some instances, an input depth model 214 can be a multilayer perceptron configured to receive frame-aligned tokens 108 as input and generate an input frame token 216 as output.

In some instances, two or more of the input depth model(s) 214, the frame model 102, and the output depth model(s) 106 can be jointly trained to facilitate the operation of multiple models on similar (e.g. same) embeddings. For example, an input depth model 214, output depth model 106, and frame model 102 can in some instances be jointly trained such that an embedding space of one or more frame tokens 104 is similar to (e.g. same as) an embedding space of one or more input frame tokens 216. In other instances, one or more models may be trained separately. For example, in some instances, a later-trained model may be trained to operate on an embedding space that is similar to (e.g. same as) a pre-existing embedding space used by an earlier-trained model.

The input frame token 216 can be, comprise, be comprised by, or share one or more properties with a frame token 104. For example, in some instances an input frame token 216 may have a similar (e.g. same) data format and embedding space as a frame token 104 or first frame token 204, such that an attention-based machine-learned model configured to generate a second frame token 218 based on a first frame token 204 can similarly generate a second frame token 218 based on an input frame token 216 instead of or in addition to a first frame token 204. In some instances, one or more input frame token(s) 216 can be, comprise, or be comprised by an initial input 116.

A frame model 102 can generate a second frame token 218 based, at least in part, on the input frame token 216. In some instances, the frame model 102 can generate the second frame token 218 based on an input context and the input frame token 216. In some instances, the frame model 102 can generate the second frame token 218 based on the input frame token 216 using an attention mechanism (e.g. causal self-attention). In some instances, an attention cache of the frame model 102 can be configured to store information associated with input frame tokens 216 (e.g. an input frame token 216 associated with each frame for which output frames 112 have previously been generated).

A second frame token 218 can be, comprise, or be comprised by a frame token 104. In some instances, the frame model 102 can generate the second frame token based on at least one of an input context and a first input frame token 216. The second frame token 218 can be associated with a second frame (e.g. second temporal frame).

A third frame token 220 can be, comprise, or be comprised by a frame token 104. In some instances, the frame model 102 can generate the third frame token based on at least one of an input context and one or more input frame tokens 216 (e.g. first input frame token associated with a first frame and second input token associated with a second frame). The third frame token 220 can be associated with a third frame (e.g. third temporal frame).

FIG. 2B is a block diagram of an example system according to the present disclosure, in which one or more input frames can be processed for use by a frame model 102. In particular, FIG. 2B depicts a tokenizer 324 obtaining input frame(s) 322 and generating one or more frame-aligned token(s) 108 based on each input frame 322. Input depth model(s) 214 can then generate one or more input frame token(s) 216 indicative of the input frame(s) 322. A frame model 102 can then autoregressively generate one or more frame tokens 104 (not pictured) based on some or all of the input frame tokens 216.

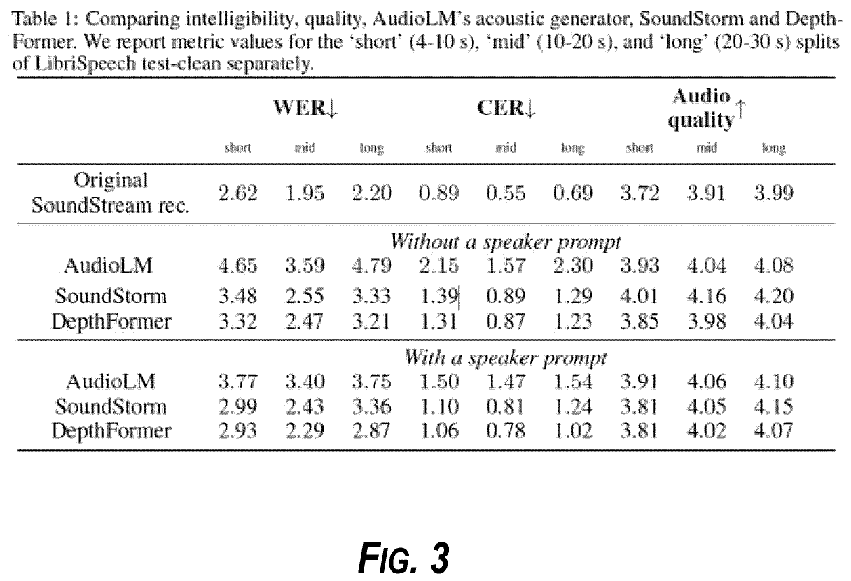

FIG. 2B depicts input frame(s) 322. The input frame(s) 322 can comprise any appropriate computer-readable data (e.g. text, audio, image, semantic data). In some instances, the input frame(s) 322 can comprise multimodal data (e.g. video data comprising audio frames, image frames, closed captioning text frames, etc.) or single-mode data (e.g. audio clip). In some instances, the input frame(s) 322 can comprise an RVQ matrix or flattened RVQ matrix. In some instances, the input frame(s) 322 can comprise one or more time-sequenced input frames (e.g. video frames, audio frames, etc.). As an illustrative example, an input context can comprise a music clip or speech audio clip, and the system of FIG. 3 can be configured to generate a musical continuation or speech continuation.

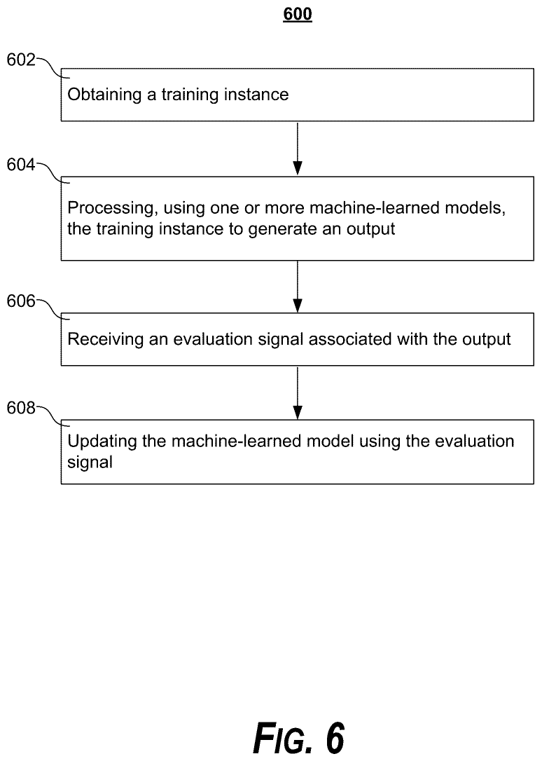

FIG. 2B depicts tokenizer(s) 324 generating frame-aligned tokens 108 based on input frame(s) 322. The tokenizer(s) 324 can be, comprise, or be implemented by a computing system (e.g. a computing system discussed with respect to FIGS. 6-15). In some instances, the tokenizer(s) 324 can be configured to split up the input frame(s) 322 into input frame portions (e.g. splitting text into words, splitting an audio waveform into 20-millisecond portions, etc.). In some instances, the tokenizer(s) 324 can comprise one or more machine-learned models (e.g. configured to embed an input frame portion into an embedded token space). In other instances, the tokenizer(s) 324 may operate without a machine-learned model (e.g. lexical tokenizer, etc.). For example, in some instances input frame(s) 322 may comprise an RVQ matrix, and a tokenizer 324 may operate by flattening the RVQ matrix and splitting it into chunks corresponding to frame-aligned tokens 108.

FIG. 2B depicts input depth model(s) 214 generating input frame token(s) 216, which a frame model 102 can use to autoregressively generate frame tokens 104 (not pictured). In some instances, these features can operate in a manner described with respect to FIG. 1 or FIG. 2A.

### Example Results

FIG. 3 shows results from an example test comparing systems and methods of the present disclosure to previous autoregressive and non-autoregressive generation methods. In FIG. 3, a system according to the present disclosure is labeled DepthFormer; an autoregressive generation method is labeled AudioLM; and a non-autoregressive generation method is labelled SoundStorm.

In the example test, a semantic encoder was used to encode original sound recordings into semantic tokens, and various systems and methods were tested for generating audio based on the semantic tokens. In this manner, the generated audio can approximately recreate the content of the original sound recording. Audio was generated for six conditions: with a speaker prompt and without a speaker prompt, for short, medium length, and long audio clips.

A system according to the present disclosure was configured to receive w2v-BERT audio semantic tokens and generate 12RVQ SoundStream audio tokens as output. Model architectures according to the present disclosure included dimensions of 1024, 64 attention heads, 16 dimensions per head, and feedforward network hidden dimension of 4096. A frame model 102 according to the present disclosure used 12 transformer layers, and a depth model 106 according to the present disclosure used 2 transformer layers. Other aspects of the test configuration (e.g. number of hours of training audio used, number of hours of test audio generated, etc.) were the same as test configurations disclosed by this application's joint inventors in AudioLM: a Language Modeling Approach to Audio Generation, which is available at https://arxiv.org/pdf/2209.03143.pdf.

The quality of the original sound recordings and the various generated audio recordings were measured in two ways. First, the recordings were given to a speech-to-text machine-learned model configured to transcribe any speech contained in the recordings. The transcriptions were compared to a ground truth transcript of the original recording. A word error rate (WER) and character error rate (CER) were computed for each transcription. Results of the comparison are shown in FIG. 3, with a system according to the present disclosure labeled DepthFormer. A low error rate is preferable to a high error rate. Advantageously, systems and methods of the present disclosure achieved lower error rates than other methods tested, at a reduced computational cost compared to other autoregressive methods tested.

Additionally, an audio reconstruction quality score was computed using a machine-learned model configured to estimate a perceived similarity between a reference audio and its reconstruction, based on a model of human sensitivity to changes in speech quality. Results of the comparison are shown in FIG. 3, with a system according to the present disclosure labeled DepthFormer. A high audio quality score is preferable to a low audio quality score. Systems and methods of the present disclosure achieved similar audio quality scores compared to other methods tested, at a reduced computational cost compared to other autoregressive methods.

### Example Methods

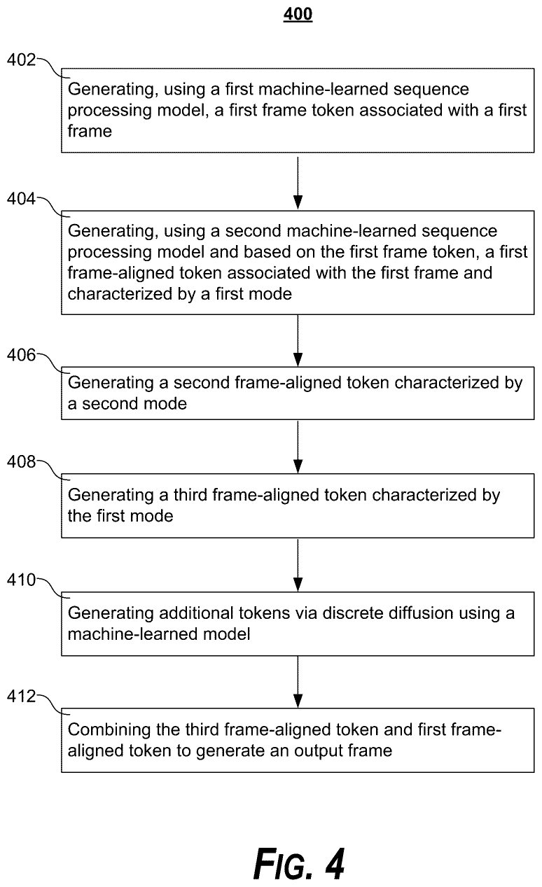

FIG. 4 depicts a flowchart diagram of an example method 400 according to the present disclosure. Example method 400 can be implemented by one or more computing systems (e.g., one or more computing systems as discussed with respect to FIGS. 1 to 15). Although FIG. 4 depicts steps performed in a particular order for purposes of illustration and discussion, the methods of the present disclosure are not limited to the particularly illustrated order or arrangement. The various steps of example method 400 can be omitted, rearranged, combined, and/or adapted in various ways without deviating from the scope of the present disclosure.

At 402, example method 400 can include generating, using a first machine-learned sequence processing model, a first frame token associated with a first frame. In some instances, the first machine-learned model can be, comprise, or be comprised by a frame model 102. In some instances, the first frame token can be, comprise, or be comprised by a frame token 104. In some instances, generating a first frame token can comprise one or more steps discussed with respect to FIG. 1.

At 404, example method 400 can include generating, using a second machine-learned sequence processing model and based on the first frame token, a first frame-aligned token associated with the first frame and characterized by a first mode. In some instances, the second machine-learned model can be, comprise, or be comprised by one or more output depth models 106. In some instances, the first frame-aligned token can be, comprise, or be comprised by a frame-aligned token 108. In some instances, the first mode can be an audio, text, image, or semantic mode. In some instances, generating a first frame-aligned token can comprise one or more steps discussed with respect to FIG. 1.

At 406, example method 400 can include generating a second frame-aligned token characterized by a second mode. In some instances, the token can be generated by one or more output depth models 106. In some instances, the token can be generated by the second machine-learned model or a third machine-learned model. In some instances, the second frame-aligned token can be generated based on the first frame token and the first frame-aligned token. In some instances, the second frame-aligned token can be a frame-aligned token 108. In some instances, the second mode can be an audio, text, image, or semantic mode. In some instances, generating a second frame-aligned token can comprise one or more steps discussed with respect to FIG. 1.

At 408, example method 400 can include generating a third frame-aligned token characterized by the first mode. In some instances, the third frame-aligned token can be generated by an output depth model 106. In some instances, the third frame-aligned token can be generated by the second machine-learned model. In some instances, the third frame-aligned token can be a frame-aligned token 108. In some instances, generating a third frame-aligned token can comprise one or more steps discussed with respect to FIG. 1.

At 410, example method 400 can include generating additional tokens via discrete diffusion using a machine-learned model. In some instances, the additional tokens can be frame-aligned tokens 408. In some instances, the additional tokens can be associated with the first mode or the second mode. In some instances, generating additional frame-aligned tokens can comprise one or more steps discussed with respect to FIG. 1.

At 412, example method 400 can include combining the third frame-aligned token and first frame-aligned token to generate an output frame. In some instances, step 412 can include combining the additional tokens with the first and third frame-aligned tokens. In some instances, step 412 can be performed by an output aggregator 110. In some instances, the output frame can be an output frame 112. In some instances, generating an output frame can comprise one or more steps discussed with respect to FIG. 1.

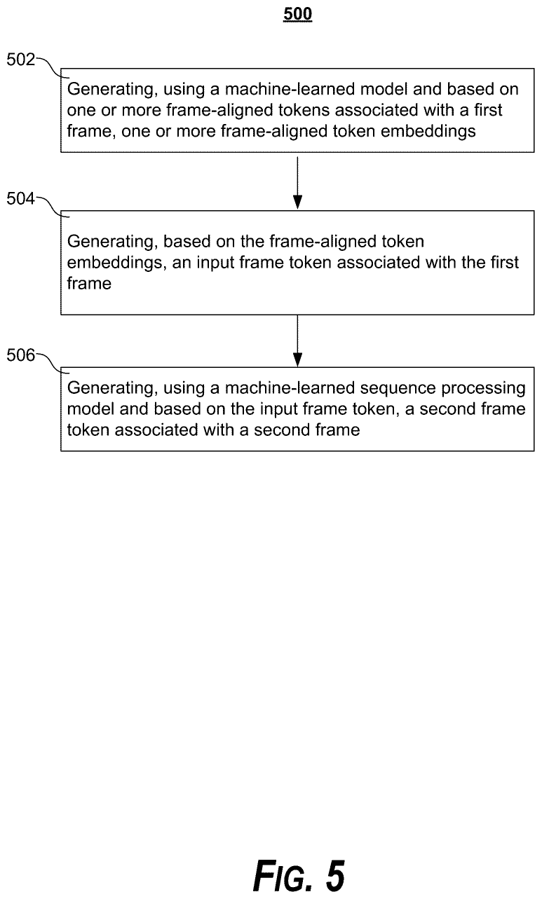

FIG. 5 depicts a flowchart diagram of an example method 500 according to the present disclosure. Example method 500 can be implemented by one or more computing systems (e.g., one or more computing systems as discussed with respect to FIGS. 1 to 15). Although FIG. 4 depicts steps performed in a particular order for purposes of illustration and discussion, the methods of the present disclosure are not limited to the particularly illustrated order or arrangement. The various steps of example method 400 can be omitted, rearranged, combined, and/or adapted in various ways without deviating from the scope of the present disclosure.

At 502, example method 500 can include generating, using a machine-learned model and based on one or more frame-aligned tokens associated with a first frame, one or more frame-aligned token embeddings. In some instances, the frame-aligned tokens can be frame-aligned tokens 108. In some instances, the embeddings can be generated by one or more input depth models 214. In some instances, generating the embeddings can include one or more steps discussed with respect to FIG. 2A or 2B.

At 504, example method 500 can include generating, based on the frame-aligned token embeddings, an input frame token associated with the first frame. In some instances, the input frame token can be generated by one or more input depth models 214. In some instances, generating the input frame token can comprise one or more steps discussed with respect to FIG. 2A or 2B.

At 506, example method 500 can include generating, using a machine-learned sequence processing model and based on the input frame token, a second frame token associated with a second frame. In some instances, the machine-learned sequence processing model can be a frame model 102. In some instances, the second frame token can be a frame token 104.

FIG. 6 depicts a flowchart of a method 600 for training one or more machine-learned models according to aspects of the present disclosure. For instance, an example machine-learned model can include a frame model 102, output depth model 106, or input depth model 214.

One or more portion(s) of example method 600 can be implemented by a computing system that includes one or more computing devices such as, for example, computing systems described with reference to the other figures. Each respective portion of example method 600 can be performed by any (or any combination) of one or more computing devices. Moreover, one or more portion(s) of example method 600 can be implemented on the hardware components of the device(s) described herein, for example, to train one or more systems or models. FIG. 6 depicts elements performed in a particular order for purposes of illustration and discussion. Those of ordinary skill in the art, using the disclosures provided herein, will understand that the elements of any of the methods discussed herein can be adapted, rearranged, expanded, omitted, combined, or modified in various ways without deviating from the scope of the present disclosure. FIG. 6 is described with reference to elements/terms described with respect to other systems and figures for exemplary illustrated purposes and is not meant to be limiting. One or more portions of example method 600 can be performed additionally, or alternatively, by other systems.

At 602, example method 600 can include obtaining a training instance. A set of training data can include a plurality of training instances divided between multiple datasets (e.g., a training dataset, a validation dataset, or testing dataset). A training instance can be labeled or unlabeled. Although referred to in example method 600 as a “training” instance, it is to be understood that runtime inferences can form training instances when a model is trained using an evaluation of the model's performance on that runtime instance (e.g., online training/learning). Example data types for the training instance and various tasks associated therewith are described throughout the present disclosure.

At 604, example method 600 can include processing, using one or more machine-learned models, the training instance to generate an output. The output can be directly obtained from the one or more machine-learned models or can be a downstream result of a chain of processing operations that includes an output of the one or more machine-learned models.

At 606, example method 600 can include receiving an evaluation signal associated with the output. The evaluation signal can be obtained using a loss function. Various determinations of loss can be used, such as mean squared error, likelihood loss, cross entropy loss, hinge loss, contrastive loss, or various other loss functions. The evaluation signal can be computed using known ground-truth labels (e.g., supervised learning), predicted or estimated labels (e.g., semi- or self-supervised learning), or without labels (e.g., unsupervised learning). The evaluation signal can be a reward (e.g., for reinforcement learning). The reward can be computed using a machine-learned reward model configured to generate rewards based on output(s) received. The reward can be computed using feedback data describing human feedback on the output(s).

At 608, example method 600 can include updating the machine-learned model using the evaluation signal. For example, values for parameters of the machine-learned model(s) can be learned, in some embodiments, using various training or learning techniques, such as, for example, backwards propagation. For example, the evaluation signal can be backpropagated from the output (or another source of the evaluation signal) through the machine-learned model(s) to update one or more parameters of the model(s) (e.g., based on a gradient of the evaluation signal with respect to the parameter value(s)). For example, system(s) containing one or more machine-learned models can be trained in an end-to-end manner. Gradient descent techniques can be used to iteratively update the parameters over a number of training iterations. In some implementations, performing backwards propagation of errors can include performing truncated backpropagation through time. Example method 600 can include implementing a number of generalization techniques (e.g., weight decays, dropouts, etc.) to improve the generalization capability of the models being trained.

In some implementations, example method 600 can be implemented for training a machine-learned model from an initialized state to a fully trained state (e.g., when the model exhibits a desired performance profile, such as based on accuracy, precision, recall, etc.).

In some implementations, example method 600 can be implemented for particular stages of a training procedure. For instance, in some implementations, example method 600 can be implemented for pre-training a machine-learned model. Pre-training can include, for instance, large-scale training over potentially noisy data to achieve a broad base of performance levels across a variety of tasks/data types. In some implementations, example method 600 can be implemented for fine-tuning a machine-learned model. Fine-tuning can include, for instance, smaller-scale training on higher-quality (e.g., labeled, curated, etc.) data. Fine-tuning can affect all or a portion of the parameters of a machine-learned model. For example, various portions of the machine-learned model can be “frozen” for certain training stages. For example, parameters associated with an embedding space can be “frozen” during fine-tuning (e.g., to retain information learned from a broader domain(s) than present in the fine-tuning dataset(s)). An example fine-tuning approach includes reinforcement learning. Reinforcement learning can be based on user feedback on model performance during use.

### Example Machine-Learned Models

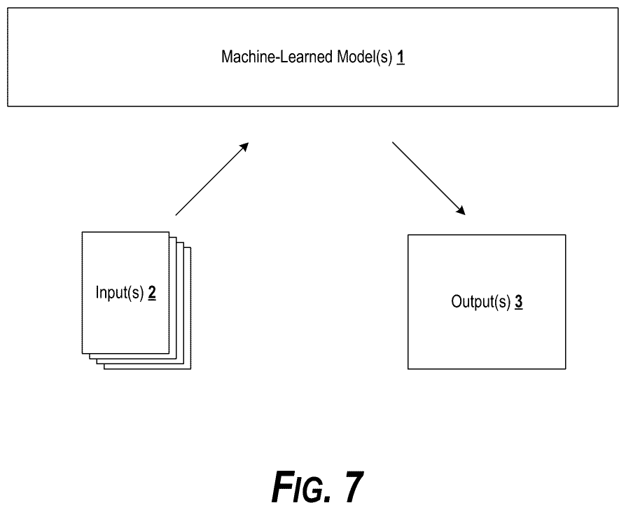

FIG. 7 is a block diagram of an example processing flow for using machine-learned model(s) 1 to process input(s) 2 to generate output(s) 3.

Machine-learned model(s) 1 can be or include one or multiple machine-learned models or model components. Example machine-learned models can include neural networks (e.g., deep neural networks). Example machine-learned models can include non-linear models or linear models. Example machine-learned models can use other architectures in lieu of or in addition to neural networks. Example machine-learned models can include decision tree based models, support vector machines, hidden Markov models, Bayesian networks, linear regression models, k-means clustering models, etc.

Example neural networks can include feed-forward neural networks, recurrent neural networks (RNNs), including long short-term memory (LSTM) based recurrent neural networks, convolutional neural networks (CNNs), diffusion models, generative-adversarial networks, or other forms of neural networks. Example neural networks can be deep neural networks. Some example machine-learned models can leverage an attention mechanism such as self-attention. For example, some example machine-learned models can include multi-headed self-attention models.

Machine-learned model(s) 1 can include a single or multiple instances of the same model configured to operate on data from input(s) 2. Machine-learned model(s) 1 can include an ensemble of different models that can cooperatively interact to process data from input(s) 2. For example, machine-learned model(s) 1 can employ a mixture-of-experts structure. See, e.g., Zhou et al., Mixture-of-Experts with Expert Choice Routing, ARXIV: 2202.09368v2 (Oct. 14, 2022).

Input(s) 2 can generally include or otherwise represent various types of data. Input(s) 2 can include one type or many different types of data. Output(s) 3 can be data of the same type(s) or of different types of data as compared to input(s) 2. Output(s) 3 can include one type or many different types of data.

Example data types for input(s) 2 or output(s) 3 include natural language text data, software code data (e.g., source code, object code, machine code, or any other form of computer-readable instructions or programming languages), machine code data (e.g., binary code, assembly code, or other forms of machine-readable instructions that can be executed directly by a computer's central processing unit), assembly code data (e.g., low-level programming languages that use symbolic representations of machine code instructions to program a processing unit), genetic data or other chemical or biochemical data, image data, audio data, audiovisual data, haptic data, biometric data, medical data, financial data, statistical data, geographical data, astronomical data, historical data, sensor data generally (e.g., digital or analog values, such as voltage or other absolute or relative level measurement values from a real or artificial input, such as from an audio sensor, light sensor, displacement sensor, etc.), and the like. Data can be raw or processed and can be in any format or schema.

In multimodal inputs 2 or outputs 3, example combinations of data types include image data and audio data, image data and natural language data, natural language data and software code data, image data and biometric data, sensor data and medical data, etc. It is to be understood that any combination of data types in an input 2 or an output 3 can be present.

An example input 2 can include one or multiple data types, such as the example data types noted above. An example output 3 can include one or multiple data types, such as the example data types noted above. The data type(s) of input 2 can be the same as or different from the data type(s) of output 3. It is to be understood that the example data types noted above are provided for illustrative purposes only. Data types contemplated within the scope of the present disclosure are not limited to those examples noted above.

### Example Machine-Learned Sequence Processing Models

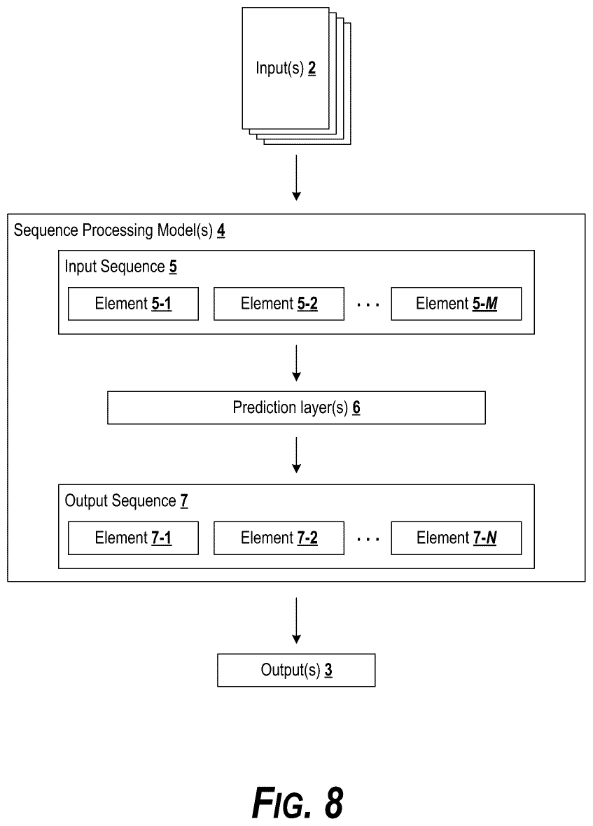

FIG. 8 is a block diagram of an example implementation of an example machine-learned model configured to process sequences of information. For instance, an example implementation of machine-learned model(s) 1 can include machine-learned sequence processing model(s) 4. An example system can pass input(s) 2 to sequence processing model(s) 4. Sequence processing model(s) 4 can include one or more machine-learned components. Sequence processing model(s) 4 can process the data from input(s) 2 to obtain an input sequence 5. Input sequence 5 can include one or more input elements 5-1, 5-2, . . . , 5-M, etc. obtained from input(s) 2. Sequence processing model 4 can process input sequence 5 using prediction layer(s) 6 to generate an output sequence 7. Output sequence 7 can include one or more output elements 7-1, 7-2, . . . , 7-N, etc. generated based on input sequence 5. The system can generate output(s) 3 based on output sequence 7.

Sequence processing model(s) 4 can include one or multiple machine-learned model components configured to ingest, generate, or otherwise reason over sequences of information. For example, some example sequence processing models in the text domain are referred to as “Large Language Models,” or LLMs. See, e.g., PaLM 2 Technical Report, GOOGLE, https://ai.google/static/documents/palm2techreport.pdf (n.d.). Other example sequence processing models can operate in other domains, such as image domains, see, e.g., Dosovitskiy et al., An Image is Worth 16×16 Words: Transformers for Image Recognition at Scale, ARXIV: 2010.11929v2 (Jun. 3, 2021), audio domains, see, e.g., Agostinelli et al., MusicLM: Generating Music From Text, ARXIV: 2301.11325v1 (Jan. 26, 2023), biochemical domains, see, e.g., Jumper et al., Highly accurate protein structure prediction with AlphaFold, 596 Nature 583 (Aug. 26, 2021), by way of example. Sequence processing model(s) 4 can process one or multiple types of data simultaneously. Sequence processing model(s) 4 can include relatively large models (e.g., more parameters, computationally expensive, etc.), relatively small models (e.g., fewer parameters, computationally lightweight, etc.), or both.

In general, sequence processing model(s) 4 can obtain input sequence 5 using data from input(s) 2. For instance, input sequence 5 can include a representation of data from input(s) 2 in a format understood by sequence processing model(s) 4. One or more machine-learned components of sequence processing model(s) 4 can ingest the data from input(s) 2, parse the data into pieces compatible with the processing architectures of sequence processing model(s) 4 (e.g., via “tokenization”), and project the pieces into an input space associated with prediction layer(s) 6 (e.g., via “embedding”).

Sequence processing model(s) 4 can ingest the data from input(s) 2 and parse the data into a sequence of elements to obtain input sequence 5. For example, a portion of input data from input(s) 2 can be broken down into pieces that collectively represent the content of the portion of the input data. The pieces can provide the elements of the sequence.

Elements 5-1, 5-2, . . . , 5-M can represent, in some cases, building blocks for capturing or expressing meaningful information in a particular data domain. For instance, the elements can describe “atomic units” across one or more domains. For example, for textual input source(s), the elements can correspond to groups of one or more words or sub-word components, such as sets of one or more characters.

For example, elements 5-1, 5-2, . . . , 5-M can represent tokens obtained using a tokenizer. For instance, a tokenizer can process a given portion of an input source and output a series of tokens (e.g., corresponding to input elements 5-1, 5-2, . . . , 5-M) that represent the portion of the input source. Various approaches to tokenization can be used. For instance, textual input source(s) can be tokenized using a byte-pair encoding (BPE) technique. See, e.g., Kudo et al., SentencePiece: A simple and language independent subword tokenizer and detokenizer for Neural Text Processing, PROCEEDINGS OF THE 2018 CONFERENCE ON EMPIRICAL METHODS IN NATURAL LANGUAGE PROCESSING (System Demonstrations), pages 66-71 (Oct. 31-Nov. 4, 2018), https://aclanthology.org/D18-2012.pdf. Image-based input source(s) can be tokenized by extracting and serializing patches from an image.

In general, arbitrary data types can be serialized and processed into input sequence 5. It is to be understood that element(s) 5-1, 5-2, . . . , 5-M depicted in FIG. 8 can be the tokens or can be the embedded representations thereof.

Prediction layer(s) 6 can predict one or more output elements 7-1, 7-2, . . . , 7-N based on the input elements. Prediction layer(s) 6 can include one or more machine-learned model architectures, such as one or more layers of learned parameters that manipulate and transform the input(s) to extract higher-order meaning from, and relationships between, input element(s) 5-1, 5-2, . . . , 5-M. In this manner, for instance, example prediction layer(s) 6 can predict new output element(s) in view of the context provided by input sequence 5.

Prediction layer(s) 6 can evaluate associations between portions of input sequence 5 and a particular output element. These associations can inform a prediction of the likelihood that a particular output follows the input context. For example, consider the textual snippet, “The carpenter's toolbox was small and heavy. It was full of ______.” Example prediction layer(s) 6 can identify that “It” refers back to “toolbox” by determining a relationship between the respective embeddings. Example prediction layer(s) 6 can also link “It” to the attributes of the toolbox, such as “small” and “heavy.” Based on these associations, prediction layer(s) 6 can, for instance, assign a higher probability to the word “nails” than to the word “sawdust.”

A transformer is an example architecture that can be used in prediction layer(s) 4. See, e.g., Vaswani et al., Attention Is All You Need, ARXIV: 1706.03762v7 (Aug. 2, 2023). A transformer is an example of a machine-learned model architecture that uses an attention mechanism to compute associations between items within a context window. The context window can include a sequence that contains input sequence 5 and potentially one or more output element(s) 7-1, 7-2, . . . , 7-N. A transformer block can include one or more attention layer(s) and one or more post-attention layer(s) (e.g., feedforward layer(s), such as a multi-layer perceptron).

Prediction layer(s) 6 can include other machine-learned model architectures in addition to or in lieu of transformer-based architectures. For example, recurrent neural networks (RNNs) and long short-term memory (LSTM) models can also be used, as well as convolutional neural networks (CNNs). In general, prediction layer(s) 6 can leverage various kinds of artificial neural networks that can understand or generate sequences of information.

Output sequence 7 can include or otherwise represent the same or different data types as input sequence 5. For instance, input sequence 5 can represent textual data, and output sequence 7 can represent textual data. Input sequence 5 can represent image, audio, or audiovisual data, and output sequence 7 can represent textual data (e.g., describing the image, audio, or audiovisual data). It is to be understood that prediction layer(s) 6, and any other interstitial model components of sequence processing model(s) 4, can be configured to receive a variety of data types in input sequence(s) 5 and output a variety of data types in output sequence(s) 7.

Output sequence 7 can have various relationships to input sequence 5. Output sequence 7 can be a continuation of input sequence 5. Output sequence 7 can be complementary to input sequence 5. Output sequence 7 can translate, transform, augment, or otherwise modify input sequence 5. Output sequence 7 can answer, evaluate, confirm, or otherwise respond to input sequence 5. Output sequence 7 can implement (or describe instructions for implementing) an instruction provided via input sequence 5.

Output sequence 7 can be generated autoregressively. For instance, for some applications, an output of one or more prediction layer(s) 6 can be passed through one or more output layers (e.g., softmax layer) to obtain a probability distribution over an output vocabulary (e.g., a textual or symbolic vocabulary) conditioned on a set of input elements in a context window. In this manner, for instance, output sequence 7 can be autoregressively generated by sampling a likely next output element, adding that element to the context window, and re-generating the probability distribution based on the updated context window, and sampling a likely next output element, and so forth.

Output sequence 7 can also be generated non-autoregressively. For instance, multiple output elements of output sequence 7 can be predicted together without explicit sequential conditioning on each other. See, e.g., Saharia et al., Non-Autoregressive Machine Translation with Latent Alignments, ARXIV: 2004.07437v3 (Nov. 16, 2020).

Output sequence 7 can include one or multiple portions or elements. In an example content generation configuration, output sequence 7 can include multiple elements corresponding to multiple portions of a generated output sequence (e.g., a textual sentence, values of a discretized waveform, computer code, etc.). In an example classification configuration, output sequence 7 can include a single element associated with a classification output. For instance, an output “vocabulary” can include a set of classes into which an input sequence is to be classified. For instance, a vision transformer block can pass latent state information to a multilayer perceptron that outputs a likely class value associated with an input image.

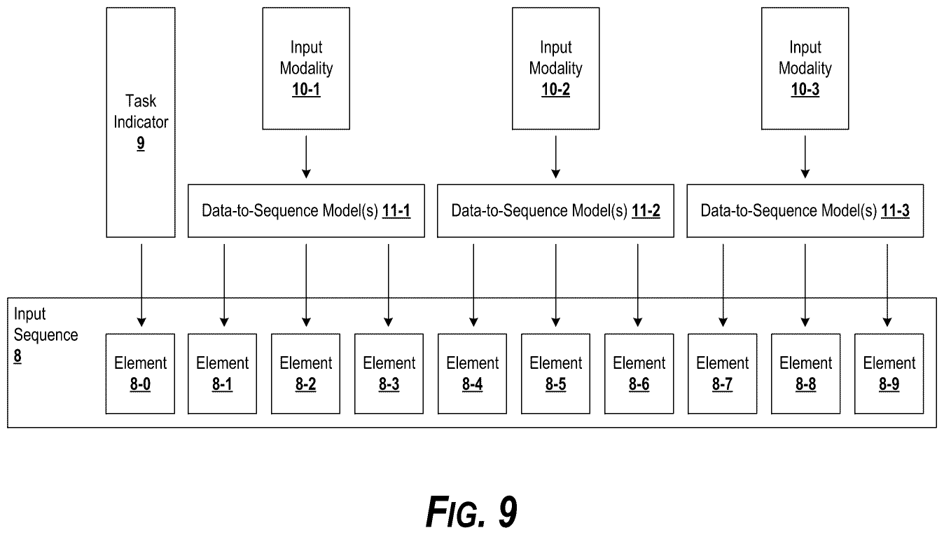

FIG. 9 is a block diagram of an example technique for populating an example input sequence 8. Input sequence 8 can include various functional elements that form part of the model infrastructure, such as an element 8-0 obtained from a task indicator 9 that signals to any model(s) that process input sequence 8 that a particular task is being performed (e.g., to help adapt a performance of the model(s) to that particular task). Input sequence 8 can include various data elements from different data modalities. For instance, an input modality 10-1 can include one modality of data. A data-to-sequence model 11-1 can process data from input modality 10-1 to project the data into a format compatible with input sequence 8 (e.g., one or more vectors dimensioned according to the dimensions of input sequence 8) to obtain elements 8-1, 8-2, 8-3. Another input modality 10-2 can include a different modality of data. A data-to-sequence model 11-2 can project data from input modality 10-2 into a format compatible with input sequence 8 to obtain elements 8-4, 8-5, 8-6. Another input modality 10-3 can include yet another different modality of data. A data-to-sequence model 11-3 can project data from input modality 10-3 into a format compatible with input sequence 8 to obtain elements 8-7, 8-8, 8-9.

Input sequence 8 can be the same as or different from input sequence 5. Input sequence 8 can be a multimodal input sequence that contains elements that represent data from different modalities using a common dimensional representation. For instance, an embedding space can have P dimensions. Input sequence 8 can be configured to contain a plurality of elements that have P dimensions. In this manner, for instance, example implementations can facilitate information extraction and reasoning across diverse data modalities by projecting data into elements in the same embedding space for comparison, combination, or other computations therebetween.

For example, elements 8-0, . . . , 8-9 can indicate particular locations within a multidimensional embedding space. Some elements can map to a set of discrete locations in the embedding space. For instance, elements that correspond to discrete members of a predetermined vocabulary of tokens can map to discrete locations in the embedding space that are associated with those tokens. Other elements can be continuously distributed across the embedding space. For instance, some data types can be broken down into continuously defined portions (e.g., image patches) that can be described using continuously distributed locations within the embedding space.

In some implementations, the expressive power of the embedding space may not be limited to meanings associated with any particular set of tokens or other building blocks. For example, a continuous embedding space can encode a spectrum of high-order information. An individual piece of information (e.g., a token) can map to a particular point in that space: for instance, a token for the word “dog” can be projected to an embedded value that points to a particular location in the embedding space associated with canine-related information. Similarly, an image patch of an image of a dog on grass can also be projected into the embedding space. In some implementations, the projection of the image of the dog can be similar to the projection of the word “dog” while also having similarity to a projection of the word “grass,” while potentially being different from both. In some implementations, the projection of the image patch may not exactly align with any single projection of a single word. In some implementations, the projection of the image patch can align with a combination of the projections of the words “dog” and “grass.” In this manner, for instance, a high-order embedding space can encode information that can be independent of data modalities in which the information is expressed.

Task indicator 9 can include a model or model component configured to identify a task being performed and inject, into input sequence 8, an input value represented by element 8-0 that signals which task is being performed. For instance, the input value can be provided as a data type associated with an input modality and projected along with that input modality (e.g., the input value can be a textual task label that is embedded along with other textual data in the input; the input value can be a pixel-based representation of a task that is embedded along with other image data in the input; etc.). The input value can be provided as a data type that differs from or is at least independent from other input(s). For instance, the input value represented by element 8-0 can be a learned within a continuous embedding space.

Input modalities 10-1, 10-2, and 10-3 can be associated with various different data types (e.g., as described above with respect to input(s) 2 and output(s) 3).

Data-to-sequence models 11-1, 11-2, and 11-3 can be the same or different from each other. Data-to-sequence models 11-1, 11-2, and 11-3 can be adapted to each respective input modality 10-1, 10-2, and 10-3. For example, a textual data-to-sequence model can subdivide a portion of input text and project the subdivisions into element(s) in input sequence 8 (e.g., elements 8-1, 8-2, 8-3, etc.). An image data-to-sequence model can subdivide an input image and project the subdivisions into element(s) in input sequence 8 (e.g., elements 8-4, 8-5, 8-6, etc.). An arbitrary datatype data-to-sequence model can subdivide an input of that arbitrary datatype and project the subdivisions into element(s) in input sequence 8 (e.g., elements 8-7, 8-8, 8-9, etc.).

Data-to-sequence models 11-1, 11-2, and 11-3 can form part of machine-learned sequence processing model(s) 4. Data-to-sequence models 11-1, 11-2, and 11-3 can be jointly trained with or trained independently from machine-learned sequence processing model(s) 4. Data-to-sequence models 11-1, 11-2, and 11-3 can be trained end-to-end with machine-learned sequence processing model(s) 4.

### Example Machine-Learned Model Development Platform

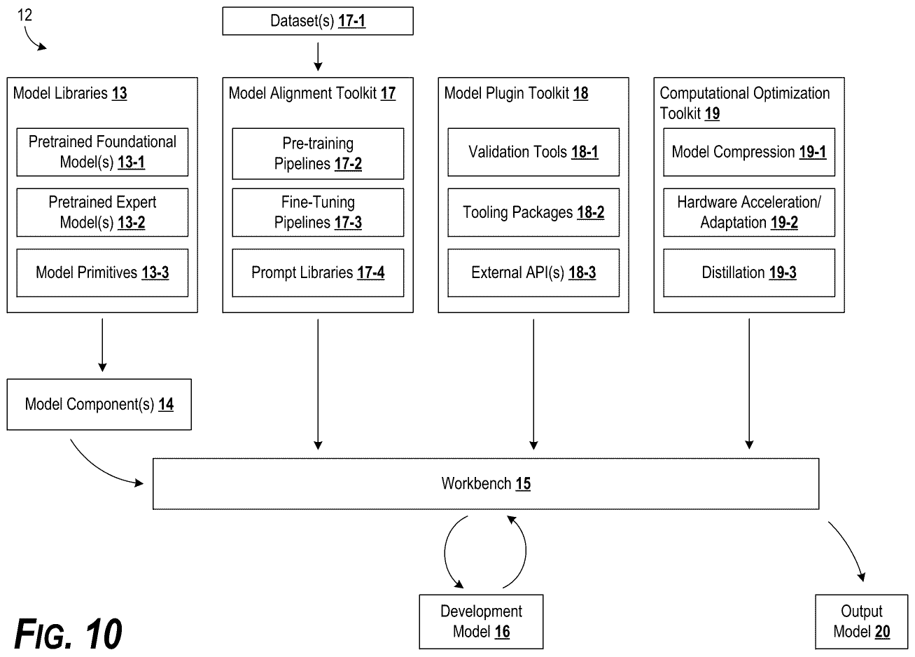

FIG. 10 is a block diagram of an example model development platform 12 that can facilitate creation, adaptation, and refinement of example machine-learned models (e.g., machine-learned model(s) 1, sequence processing model(s) 4, etc.). Model development platform 12 can provide a number of different toolkits that developer systems can employ in the development of new or adapted machine-learned models.

Model development platform 12 can provide one or more model libraries 13 containing building blocks for new models. Model libraries 13 can include one or more pre-trained foundational models 13-1, which can provide a backbone of processing power across various tasks. Model libraries 13 can include one or more pre-trained expert models 13-2, which can be focused on performance in particular domains of expertise. Model libraries 13 can include various model primitives 13-3, which can provide low-level architectures or components (optionally pre-trained), which can be assembled in various arrangements as desired.

Model development platform 12 can receive selections of various model components 14. Model development platform 12 can pass selected model components 14 to a workbench 15 that combines selected model components 14 into a development model 16.

Workbench 15 can facilitate further refinement and adaptation of development model 16 by leveraging a number of different toolkits integrated with model development platform 12. For example, workbench 15 can facilitate alignment of the development model 16 with a desired performance profile on various tasks using a model alignment toolkit 17.

Model alignment toolkit 17 can provide a number of tools for causing development model 16 to generate outputs aligned with desired behavioral characteristics. Alignment can include increasing an accuracy, precision, recall, etc. of model outputs. Alignment can include enforcing output styles, schema, or other preferential characteristics of model outputs. Alignment can be general or domain-specific. For instance, a pre-trained foundational model 13-1 can begin with an initial level of performance across multiple domains. Alignment of the pre-trained foundational model 13-1 can include improving a performance in a particular domain of information or tasks (e.g., even at the expense of performance in another domain of information or tasks).

Model alignment toolkit 17 can integrate one or more dataset(s) 17-1 for aligning development model 16. Curated dataset(s) 17-1 can include labeled or unlabeled training data. Dataset(s) 17-1 can be obtained from public domain datasets. Dataset(s) 17-1 can be obtained from private datasets associated with one or more developer system(s) for the alignment of bespoke machine-learned model(s) customized for private use-cases.

Pre-training pipelines 17-2 can include a machine-learned model training workflow configured to update development model 16 over large-scale, potentially noisy datasets. For example, pre-training can leverage unsupervised learning techniques (e.g., de-noising, etc.) to process large numbers of training instances to update model parameters from an initialized state and achieve a desired baseline performance. Pre-training pipelines 17-2 can leverage unlabeled datasets in dataset(s) 17-1 to perform pre-training. Workbench 15 can implement a pre-training pipeline 17-2 to pre-train development model 16.

Fine-tuning pipelines 17-3 can include a machine-learned model training workflow configured to refine the model parameters of development model 16 with higher-quality data. Fine-tuning pipelines 17-3 can update development model 16 by conducting supervised training with labeled dataset(s) in dataset(s) 17-1. Fine-tuning pipelines 17-3 can update development model 16 by conducting reinforcement learning using reward signals from user feedback signals. Workbench 15 can implement a fine-tuning pipeline 17-3 to fine-tune development model 16.

Prompt libraries 17-4 can include sets of inputs configured to induce behavior aligned with desired performance criteria. Prompt libraries 17-4 can include few-shot prompts (e.g., inputs providing examples of desired model outputs for prepending to a desired runtime query), chain-of-thought prompts (e.g., inputs providing step-by-step reasoning within the exemplars to facilitate thorough reasoning by the model), and the like.

Example prompts can be retrieved from an available repository of prompt libraries 17-4. Example prompts can be contributed by one or more developer systems using workbench 15.

In some implementations, pre-trained or fine-tuned models can achieve satisfactory performance without exemplars in the inputs. For instance, zero-shot prompts can include inputs that lack exemplars. Zero-shot prompts can be within a domain within a training dataset or outside of the training domain(s).

Prompt libraries 17-4 can include one or more prompt engineering tools. Prompt engineering tools can provide workflows for retrieving or learning optimized prompt values. Prompt engineering tools can facilitate directly learning prompt values (e.g., input element values) based one or more training iterations. Workbench 15 can implement prompt engineering tools in development model 16.

Prompt libraries 17-4 can include pipelines for prompt generation. For example, inputs can be generated using development model 16 itself or other machine-learned models. In this manner, for instance, a first model can process information about a task and output a input for a second model to process in order to perform a step of the task. The second model can be the same as or different from the first model. Workbench 15 can implement prompt generation pipelines in development model 16.

Prompt libraries 17-4 can include pipelines for context injection. For instance, a performance of development model 16 on a particular task can improve if provided with additional context for performing the task. Prompt libraries 17-4 can include software components configured to identify desired context, retrieve the context from an external source (e.g., a database, a sensor, etc.), and add the context to the input prompt. Workbench 15 can implement context injection pipelines in development model 16.

Although various training examples described herein with respect to model development platform 12 refer to “pre-training” and “fine-tuning,” it is to be understood that model alignment toolkit 17 can generally support a wide variety of training techniques adapted for training a wide variety of machine-learned models. Example training techniques can correspond to the example training method 600 described above.

Model development platform 12 can include a model plugin toolkit 18. Model plugin toolkit 18 can include a variety of tools configured for augmenting the functionality of a machine-learned model by integrating the machine-learned model with other systems, devices, and software components. For instance, a machine-learned model can use tools to increase performance quality where appropriate. For instance, deterministic tasks can be offloaded to dedicated tools in lieu of probabilistically performing the task with an increased risk of error. For instance, instead of autoregressively predicting the solution to a system of equations, a machine-learned model can recognize a tool to call for obtaining the solution and pass the system of equations to the appropriate tool. The tool can be a traditional system of equations solver that can operate deterministically to resolve the system of equations. The output of the tool can be returned in response to the original query. In this manner, tool use can allow some example models to focus on the strengths of machine-learned models—e.g., understanding an intent in an unstructured request for a task—while augmenting the performance of the model by offloading certain tasks to a more focused tool for rote application of deterministic algorithms to a well-defined problem.

Model plugin toolkit 18 can include validation tools 18-1. Validation tools 18-1 can include tools that can parse and confirm output(s) of a machine-learned model. Validation tools 18-1 can include engineered heuristics that establish certain thresholds applied to model outputs. For example, validation tools 18-1 can ground the outputs of machine-learned models to structured data sources (e.g., to mitigate “hallucinations”).

Model plugin toolkit 18 can include tooling packages 18-2 for implementing one or more tools that can include scripts or other executable code that can be executed alongside development model 16. Tooling packages 18-2 can include one or more inputs configured to cause machine-learned model(s) to implement the tools (e.g., few-shot prompts that induce a model to output tool calls in the proper syntax, etc.). Tooling packages 18-2 can include, for instance, fine-tuning training data for training a model to use a tool.

Model plugin toolkit 18 can include interfaces for calling external application programming interfaces (APIs) 18-3. For instance, in addition to or in lieu of implementing tool calls or tool code directly with development model 16, development model 16 can be aligned to output instruction that initiate API calls to send or obtain data via external systems.

Model plugin toolkit 18 can integrate with prompt libraries 17-4 to build a catalog of available tools for use with development model 16. For instance, a model can receive, in an input, a catalog of available tools, and the model can generate an output that selects a tool from the available tools and initiates a tool call for using the tool.

Model development platform 12 can include a computational optimization toolkit 19 for optimizing a computational performance of development model 16. For instance, tools for model compression 19-1 can allow development model 16 to be reduced in size while maintaining a desired level of performance. For instance, model compression 19-1 can include quantization workflows, weight pruning and sparsification techniques, etc. Tools for hardware acceleration 19-2 can facilitate the configuration of the model storage and execution formats to operate optimally on different hardware resources. For instance, hardware acceleration 19-2 can include tools for optimally sharding models for distributed processing over multiple processing units for increased bandwidth, lower unified memory requirements, etc. Tools for distillation 19-3 can provide for the training of lighter-weight models based on the knowledge encoded in development model 16. For instance, development model 16 can be a highly performant, large machine-learned model optimized using model development platform 12. To obtain a lightweight model for running in resource-constrained environments, a smaller model can be a “student model” that learns to imitate development model 16 as a “teacher model.” In this manner, for instance, the investment in learning the parameters and configurations of development model 16 can be efficiently transferred to a smaller model for more efficient inference.

Workbench 15 can implement one, multiple, or none of the toolkits implemented in model development platform 12. Workbench 15 can output an output model 20 based on development model 16. Output model 20 can be a deployment version of development model 16. Output model 20 can be a development or training checkpoint of development model 16. Output model 20 can be a distilled, compressed, or otherwise optimized version of development model 16.

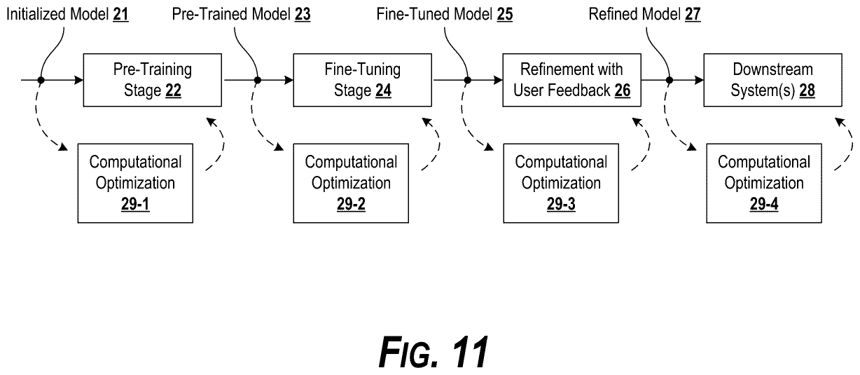

FIG. 11 is a block diagram of an example training flow for training a machine-learned development model 16. One or more portion(s) of the example training flow can be implemented by a computing system that includes one or more computing devices such as, for example, computing systems described with reference to the other figures. Each respective portion of the example training flow can be performed by any (or any combination) of one or more computing devices. Moreover, one or more portion(s) of the example training flow can be implemented on the hardware components of the device(s) described herein, for example, to train one or more systems or models. FIG. 11 depicts elements performed in a particular order for purposes of illustration and discussion. Those of ordinary skill in the art, using the disclosures provided herein, will understand that the elements of any of the methods discussed herein can be adapted, rearranged, expanded, omitted, combined, or modified in various ways without deviating from the scope of the present disclosure. FIG. 11 is described with reference to elements/terms described with respect to other systems and figures for exemplary illustrated purposes and is not meant to be limiting. One or more portions of the example training flow can be performed additionally, or alternatively, by other systems.

Initially, development model 16 can persist in an initial state as an initialized model 21. Development model 16 can be initialized with weight values. Initial weight values can be random or based on an initialization schema. Initial weight values can be based on prior pre-training for the same or for a different model.

Initialized model 21 can undergo pre-training in a pre-training stage 22. Pre-training stage 22 can be implemented using one or more pre-training pipelines 17-2 over data from dataset(s) 17-1. Pre-training can be omitted, for example, if initialized model 21 is already pre-trained (e.g., development model 16 contains, is, or is based on a pre-trained foundational model or an expert model).

Pre-trained model 23 can then be a new version of development model 16, which can persist as development model 16 or as a new development model. Pre-trained model 23 can be the initial state if development model 16 was already pre-trained. Pre-trained model 23 can undergo fine-tuning in a fine-tuning stage 24. Fine-tuning stage 24 can be implemented using one or more fine-tuning pipelines 17-3 over data from dataset(s) 17-1. Fine-tuning can be omitted, for example, if a pre-trained model as satisfactory performance, if the model was already fine-tuned, or if other tuning approaches are preferred.

Fine-tuned model 29 can then be a new version of development model 16, which can persist as development model 16 or as a new development model. Fine-tuned model 29 can be the initial state if development model 16 was already fine-tuned. Fine-tuned model 29 can undergo refinement with user feedback 26. For instance, refinement with user feedback 26 can include reinforcement learning, optionally based on human feedback from human users of fine-tuned model 25. As reinforcement learning can be a form of fine-tuning, it is to be understood that fine-tuning stage 24 can subsume the stage for refining with user feedback 26. Refinement with user feedback 26 can produce a refined model 27. Refined model 27 can be output to downstream system(s) 28 for deployment or further development.

In some implementations, computational optimization operations can be applied before, during, or after each stage. For instance, initialized model 21 can undergo computational optimization 29-1 (e.g., using computational optimization toolkit 19) before pre-training stage 22. Pre-trained model 23 can undergo computational optimization 29-2 (e.g., using computational optimization toolkit 19) before fine-tuning stage 24. Fine-tuned model 25 can undergo computational optimization 29-3 (e.g., using computational optimization toolkit 19) before refinement with user feedback 26. Refined model 27 can undergo computational optimization 29-4 (e.g., using computational optimization toolkit 19) before output to downstream system(s) 28. Computational optimization(s) 29-1, . . . , 29-4 can all be the same, all be different, or include at least some different optimization techniques.

### Example Machine-Learned Model Inference System

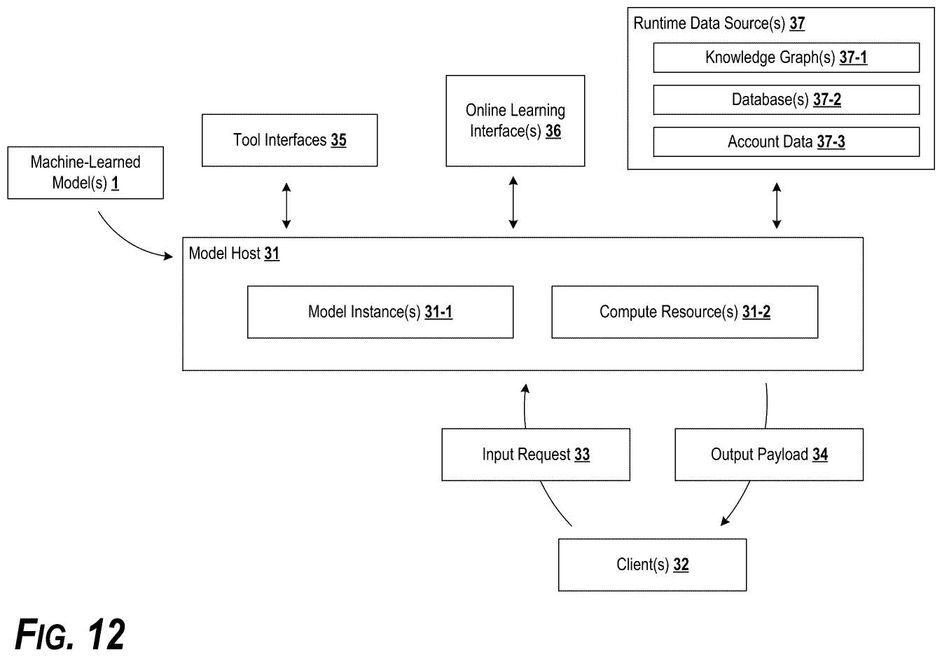

FIG. 12 is a block diagram of an inference system for operating one or more machine-learned model(s) 1 to perform inference (e.g., for training, for deployment, etc.). A model host 31 can receive machine-learned model(s) 1. Model host 31 can host one or more model instance(s) 31-1, which can be one or multiple instances of one or multiple models. Model host 31 can host model instance(s) 31-1 using available compute resources 31-2 associated with model host 31.

Model host 31 can perform inference on behalf of one or more client(s) 32. Client(s) 32 can transmit an input request 33 to model host 31. Using input request 33, model host 31 can obtain input(s) 2 for input to machine-learned model(s) 1. Machine-learned model(s) 1 can process input(s) 2 to generate output(s) 3. Using output(s) 3, model host 31 can return an output payload 34 for responding to input request 33 from client(s) 32. Output payload 34 can include or be based on output(s) 3.

Model host 31 can leverage various other resources and tools to augment the inference task. For instance, model host 31 can communicate with tool interfaces 35 to facilitate tool use by model instance(s) 31-1. Tool interfaces 35 can include local or remote APIs. Tool interfaces 35 can include integrated scripts or other software functionality. Model host 31 can engage online learning interface(s) 36 to facilitate ongoing improvements to machine-learned model(s) 1. For instance, online learning interface(s) 36 can be used within reinforcement learning loops to retrieve user feedback on inferences served by model host 31. Model host 31 can access runtime data source(s) 37 for augmenting input(s) 2 with additional contextual information. For instance, runtime data source(s) 37 can include a knowledge graph 37-1 that facilitates structured information retrieval for information associated with input request(s) 33 (e.g., a search engine service). Runtime data source(s) 37 can include public or private, external or local database(s) 37-2 that can store information associated with input request(s) 33 for augmenting input(s) 2. Runtime data source(s) 37 can include account data 37-3 which can be retrieved in association with a user account corresponding to a client 32 for customizing the behavior of model host 31 accordingly.

Model host 31 can be implemented by one or multiple computing devices or systems. Client(s) 2 can be implemented by one or multiple computing devices or systems, which can include computing devices or systems shared with model host 31.

For example, model host 31 can operate on a server system that provides a machine-learning service to client device(s) that operate client(s) 32 (e.g., over a local or wide-area network). Client device(s) can be end-user devices used by individuals. Client device(s) can be server systems that operate client(s) 32 to provide various functionality as a service to downstream end-user devices.

In some implementations, model host 31 can operate on a same device or system as client(s) 32. Model host 31 can be a machine-learning service that runs on-device to provide machine-learning functionality to one or multiple applications operating on a client device, which can include an application implementing client(s) 32. Model host 31 can be a part of a same application as client(s) 32. For instance, model host 31 can be a subroutine or method implemented by one part of an application, and client(s) 32 can be another subroutine or method that engages model host 31 to perform inference functions within the application. It is to be understood that model host 31 and client(s) 32 can have various different configurations.

Model instance(s) 31-1 can include one or more machine-learned models that are available for performing inference. Model instance(s) 31-1 can include weights or other model components that are stored on in persistent storage, temporarily cached, or loaded into high-speed memory. Model instance(s) 31-1 can include multiple instance(s) of the same model (e.g., for parallel execution of more requests on the same model). Model instance(s) 31-1 can include instance(s) of different model(s). Model instance(s) 31-1 can include cached intermediate states of active or inactive model(s) used to accelerate inference of those models. For instance, an inference session with a particular model may generate significant amounts of computational results that can be re-used for future inference runs (e.g., using a KV cache for transformer-based models). These computational results can be saved in association with that inference session so that session can be executed more efficiently when resumed.

Compute resource(s) 31-2 can include one or more processors (central processing units, graphical processing units, tensor processing units, machine-learning accelerators, etc.) connected to one or more memory devices. Compute resource(s) 31-2 can include a dynamic pool of available resources shared with other processes. Compute resource(s) 31-2 can include memory devices large enough to fit an entire model instance in a single memory instance. Compute resource(s) 31-2 can also shard model instance(s) across multiple memory devices (e.g., using data parallelization or tensor parallelization, etc.). This can be done to increase parallelization or to execute a large model using multiple memory devices which individually might not be able to fit the entire model into memory.

Input request 33 can include data for input(s) 2. Model host 31 can process input request 33 to obtain input(s) 2. Input(s) 2 can be obtained directly from input request 33 or can be retrieved using input request 33. Input request 33 can be submitted to model host 31 via an API.

Model host 31 can perform inference over batches of input requests 33 in parallel. For instance, a model instance 31-1 can be configured with an input structure that has a batch dimension. Separate input(s) 2 can be distributed across the batch dimension (e.g., rows of an array). The separate input(s) 2 can include completely different contexts. The separate input(s) 2 can be multiple inference steps of the same task. The separate input(s) 2 can be staggered in an input structure, such that any given inference cycle can be operating on different portions of the respective input(s) 2. In this manner, for instance, model host 31 can perform inference on the batch in parallel, such that output(s) 3 can also contain the batch dimension and return the inference results for the batched input(s) 2 in parallel. In this manner, for instance, batches of input request(s) 33 can be processed in parallel for higher throughput of output payload(s) 34.

Output payload 34 can include or be based on output(s) 3 from machine-learned model(s) 1. Model host 31 can process output(s) 3 to obtain output payload 34. This can include chaining multiple rounds of inference (e.g., iteratively, recursively, across the same model(s) or different model(s)) to arrive at a final output for a task to be returned in output payload 34. Output payload 34 can be transmitted to client(s) 32 via an API.

Online learning interface(s) 36 can facilitate reinforcement learning of machine-learned model(s) 1. Online learning interface(s) 36 can facilitate reinforcement learning with human feedback (RLHF). Online learning interface(s) 36 can facilitate federated learning of machine-learned model(s) 1.

Model host 31 can execute machine-learned model(s) 1 to perform inference for various tasks using various types of data. For example, various different input(s) 2 and output(s) 3 can be used for various different tasks. In some implementations, input(s) 2 can be or otherwise represent image data. Machine-learned model(s) 1 can process the image data to generate an output. As an example, machine-learned model(s) 1 can process the image data to generate an image recognition output (e.g., a recognition of the image data, a latent embedding of the image data, an encoded representation of the image data, a hash of the image data, etc.). As another example, machine-learned model(s) 1 can process the image data to generate an image segmentation output. As another example, machine-learned model(s) 1 can process the image data to generate an image classification output. As another example, machine-learned model(s) 1 can process the image data to generate an image data modification output (e.g., an alteration of the image data, etc.). As another example, machine-learned model(s) 1 can process the image data to generate an encoded image data output (e.g., an encoded and/or compressed representation of the image data, etc.). As another example, machine-learned model(s) 1 can process the image data to generate an upscaled image data output. As another example, machine-learned model(s) 1 can process the image data to generate a prediction output.

In some implementations, the task is a computer vision task. In some cases, input(s) 2 includes pixel data for one or more images and the task is an image processing task. For example, the image processing task can be image classification, where the output is a set of scores, each score corresponding to a different object class and representing the likelihood that the one or more images depict an object belonging to the object class. The image processing task may be object detection, where the image processing output identifies one or more regions in the one or more images and, for each region, a likelihood that region depicts an object of interest. As another example, the image processing task can be image segmentation, where the image processing output defines, for each pixel in the one or more images, a respective likelihood for each category in a predetermined set of categories. For example, the set of categories can be foreground and background. As another example, the set of categories can be object classes. As another example, the image processing task can be depth estimation, where the image processing output defines, for each pixel in the one or more images, a respective depth value. As another example, the image processing task can be motion estimation, where the network input includes multiple images, and the image processing output defines, for each pixel of one of the input images, a motion of the scene depicted at the pixel between the images in the network input.

In some implementations, input(s) 2 can be or otherwise represent natural language data. Machine-learned model(s) 1 can process the natural language data to generate an output. As an example, machine-learned model(s) 1 can process the natural language data to generate a language encoding output. As another example, machine-learned model(s) 1 can process the natural language data to generate a latent text embedding output. As another example, machine-learned model(s) 1 can process the natural language data to generate a translation output. As another example, machine-learned model(s) 1 can process the natural language data to generate a classification output. As another example, machine-learned model(s) 1 can process the natural language data to generate a textual segmentation output. As another example, machine-learned model(s) 1 can process the natural language data to generate a semantic intent output. As another example, machine-learned model(s) 1 can process the natural language data to generate an upscaled text or natural language output (e.g., text or natural language data that is higher quality than the input text or natural language, etc.). As another example, machine-learned model(s) 1 can process the natural language data to generate a prediction output (e.g., one or more predicted next portions of natural language content).

In some implementations, input(s) 2 can be or otherwise represent speech data (e.g., data describing spoken natural language, such as audio data, textual data, etc.). Machine-learned model(s) 1 can process the speech data to generate an output. As an example, machine-learned model(s) 1 can process the speech data to generate a speech recognition output. As another example, machine-learned model(s) 1 can process the speech data to generate a speech translation output. As another example, machine-learned model(s) 1 can process the speech data to generate a latent embedding output. As another example, machine-learned model(s) 1 can process the speech data to generate an encoded speech output (e.g., an encoded and/or compressed representation of the speech data, etc.). As another example, machine-learned model(s) 1 can process the speech data to generate an upscaled speech output (e.g., speech data that is higher quality than the input speech data, etc.). As another example, machine-learned model(s) 1 can process the speech data to generate a textual representation output (e.g., a textual representation of the input speech data, etc.). As another example, machine-learned model(s) 1 can process the speech data to generate a prediction output.

In some implementations, input(s) 2 can be or otherwise represent latent encoding data (e.g., a latent space representation of an input, etc.). Machine-learned model(s) 1 can process the latent encoding data to generate an output. As an example, machine-learned model(s) 1 can process the latent encoding data to generate a recognition output. As another example, machine-learned model(s) 1 can process the latent encoding data to generate a reconstruction output. As another example, machine-learned model(s) 1 can process the latent encoding data to generate a search output. As another example, machine-learned model(s) 1 can process the latent encoding data to generate a reclustering output. As another example, machine-learned model(s) 1 can process the latent encoding data to generate a prediction output.

In some implementations, input(s) 2 can be or otherwise represent statistical data. Statistical data can be, represent, or otherwise include data computed and/or calculated from some other data source. Machine-learned model(s) 1 can process the statistical data to generate an output. As an example, machine-learned model(s) 1 can process the statistical data to generate a recognition output. As another example, machine-learned model(s) 1 can process the statistical data to generate a prediction output. As another example, machine-learned model(s) 1 can process the statistical data to generate a classification output. As another example, machine-learned model(s) 1 can process the statistical data to generate a segmentation output. As another example, machine-learned model(s) 1 can process the statistical data to generate a visualization output. As another example, machine-learned model(s) 1 can process the statistical data to generate a diagnostic output.

In some implementations, input(s) 2 can be or otherwise represent sensor data. Machine-learned model(s) 1 can process the sensor data to generate an output. As an example, machine-learned model(s) 1 can process the sensor data to generate a recognition output. As another example, machine-learned model(s) 1 can process the sensor data to generate a prediction output. As another example, machine-learned model(s) 1 can process the sensor data to generate a classification output. As another example, machine-learned model(s) 1 can process the sensor data to generate a segmentation output. As another example, machine-learned model(s) 1 can process the sensor data to generate a visualization output. As another example, machine-learned model(s) 1 can process the sensor data to generate a diagnostic output. As another example, machine-learned model(s) 1 can process the sensor data to generate a detection output.

In some implementations, machine-learned model(s) 1 can be configured to perform a task that includes encoding input data for reliable and/or efficient transmission or storage (and/or corresponding decoding). For example, the task may be an audio compression task. The input may include audio data and the output may comprise compressed audio data. In another example, the input includes visual data (e.g. one or more images or videos), the output comprises compressed visual data, and the task is a visual data compression task. In another example, the task may comprise generating an embedding for input data (e.g. input audio or visual data). In some cases, the input includes audio data representing a spoken utterance and the task is a speech recognition task. The output may comprise a text output which is mapped to the spoken utterance. In some cases, the task comprises encrypting or decrypting input data. In some cases, the task comprises a microprocessor performance task, such as branch prediction or memory address translation.

In some implementations, the task is a generative task, and machine-learned model(s) 1 can be configured to output content generated in view of input(s) 2. For instance, input(s) 2 can be or otherwise represent data of one or more modalities that encodes context for generating additional content.

In some implementations, the task can be a text completion task. Machine-learned model(s) 1 can be configured to process input(s) 2 that represent textual data and to generate output(s) 3 that represent additional textual data that completes a textual sequence that includes input(s) 2. For instance, machine-learned model(s) 1 can be configured to generate output(s) 3 to complete a sentence, paragraph, or portion of text that follows from a portion of text represented by input(s) 2.

In some implementations, the task can be an instruction following task. Machine-learned model(s) 1 can be configured to process input(s) 2 that represent instructions to perform a function and to generate output(s) 3 that advance a goal of satisfying the instruction function (e.g., at least a step of a multi-step procedure to perform the function). Output(s) 3 can represent data of the same or of a different modality as input(s) 2. For instance, input(s) 2 can represent textual data (e.g., natural language instructions for a task to be performed) and machine-learned model(s) 1 can process input(s) 2 to generate output(s) 3 that represent textual data responsive to the instructions (e.g., natural language responses, programming language responses, machine language responses, etc.). Input(s) 2 can represent image data (e.g., image-based instructions for a task to be performed, optionally accompanied by textual instructions) and machine-learned model(s) 1 can process input(s) 2 to generate output(s) 3 that represent textual data responsive to the instructions (e.g., natural language responses, programming language responses, machine language responses, etc.). One or more output(s) 3 can be iteratively or recursively generated to sequentially process and accomplish steps toward accomplishing the requested functionality. For instance, an initial output can be executed by an external system or be processed by machine-learned model(s) 1 to complete an initial step of performing a function. Multiple steps can be performed, with a final output being obtained that is responsive to the initial instructions.

In some implementations, the task can be a question answering task. Machine-learned model(s) 1 can be configured to process input(s) 2 that represent a question to answer and to generate output(s) 3 that advance a goal of returning an answer to the question (e.g., at least a step of a multi-step procedure to perform the function). Output(s) 3 can represent data of the same or of a different modality as input(s) 2. For instance, input(s) 2 can represent textual data (e.g., natural language instructions for a task to be performed) and machine-learned model(s) 1 can process input(s) 2 to generate output(s) 3 that represent textual data responsive to the question (e.g., natural language responses, programming language responses, machine language responses, etc.). Input(s) 2 can represent image data (e.g., image-based instructions for a task to be performed, optionally accompanied by textual instructions) and machine-learned model(s) 1 can process input(s) 2 to generate output(s) 3 that represent textual data responsive to the question (e.g., natural language responses, programming language responses, machine language responses, etc.). One or more output(s) 3 can be iteratively or recursively generated to sequentially process and accomplish steps toward answering the question. For instance, an initial output can be executed by an external system or be processed by machine-learned model(s) 1 to complete an initial step of obtaining an answer to the question (e.g., querying a database, performing a computation, executing a script, etc.). Multiple steps can be performed, with a final output being obtained that is responsive to the question.

In some implementations, the task can be an image generation task. Machine-learned model(s) 1 can be configured to process input(s) 2 that represent context regarding a desired portion of image content. The context can include text data, image data, audio data, etc. Machine-learned model(s) 1 can be configured to generate output(s) 3 that represent image data that depicts imagery related to the context. For instance, machine-learned model(s) 1 can be configured to generate pixel data of an image. Values for channel(s) associated with the pixels in the pixel data can be selected based on the context (e.g., based on a probability determined based on the context).

In some implementations, the task can be an audio generation task. Machine-learned model(s) 1 can be configured to process input(s) 2 that represent context regarding a desired portion of audio content. The context can include text data, image data, audio data, etc. Machine-learned model(s) 1 can be configured to generate output(s) 3 that represent audio data related to the context. For instance, machine-learned model(s) 1 can be configured to generate waveform data in the form of an image (e.g., a spectrogram). Values for channel(s) associated with pixels of the image can be selected based on the context. Machine-learned model(s) 1 can be configured to generate waveform data in the form of a sequence of discrete samples of a continuous waveform. Values of the sequence can be selected based on the context (e.g., based on a probability determined based on the context).

In some implementations, the task can be a data generation task. Machine-learned model(s) 1 can be configured to process input(s) 2 that represent context regarding a desired portion of data (e.g., data from various data domains, such as sensor data, image data, multimodal data, statistical data, etc.). The desired data can be, for instance, synthetic data for training other machine-learned models. The context can include arbitrary data type(s). Machine-learned model(s) 1 can be configured to generate output(s) 3 that represent data that aligns with the desired data. For instance, machine-learned model(s) 1 can be configured to generate data values for populating a dataset. Values for the data object(s) can be selected based on the context (e.g., based on a probability determined based on the context).

### Example Computing Systems and Devices

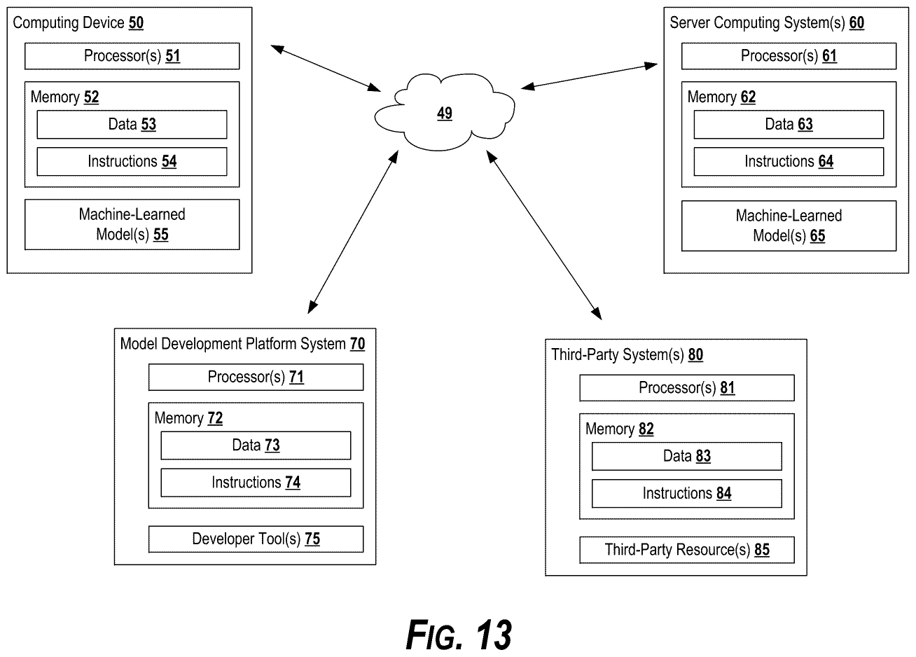

FIG. 13 is a block diagram of an example networked computing system that can perform aspects of example implementations of the present disclosure. The system can include a number of computing devices and systems that are communicatively coupled over a network 49. An example computing device 50 is described to provide an example of a computing device that can perform any aspect of the present disclosure (e.g., implementing model host 31, client(s) 32, or both). An example server computing system 60 is described as an example of a server computing system that can perform any aspect of the present disclosure (e.g., implementing model host 31, client(s) 32, or both). Computing device 50 and server computing system(s) 60 can cooperatively interact (e.g., over network 49) to perform any aspect of the present disclosure (e.g., implementing model host 31, client(s) 32, or both). Model development platform system 70 is an example system that can host or serve model development platform(s) 12 for development of machine-learned models. Third-party system(s) 80 are example system(s) with which any of computing device 50, server computing system(s) 60, or model development platform system(s) 70 can interact in the performance of various aspects of the present disclosure (e.g., engaging third-party tools, accessing third-party databases or other resources, etc.).

Network 49 can be any type of communications network, such as a local area network (e.g., intranet), wide area network (e.g., Internet), or some combination thereof and can include any number of wired or wireless links. In general, communication over network 49 can be carried via any type of wired or wireless connection, using a wide variety of communication protocols (e.g., TCP/IP, HTTP, SMTP, FTP), encodings or formats (e.g., HTML, XML), or protection schemes (e.g., VPN, secure HTTP, SSL). Network 49 can also be implemented via a system bus. For instance, one or more devices or systems of FIG. 13 can be co-located with, contained by, or otherwise integrated into one or more other devices or systems.

Computing device 50 can be any type of computing device, such as, for example, a personal computing device (e.g., laptop or desktop), a mobile computing device (e.g., smartphone or tablet), a gaming console or controller, a wearable computing device, an embedded computing device, a server computing device, a virtual machine operating on a host device, or any other type of computing device. Computing device 50 can be a client computing device. Computing device 50 can be an end-user computing device. Computing device 50 can be a computing device of a service provided that provides a service to an end user (who may use another computing device to interact with computing device 50).

Computing device 50 can include one or more processors 51 and a memory 52. Processor(s) 51 can be any suitable processing device (e.g., a processor core, a microprocessor, an ASIC, an FPGA, a controller, a microcontroller, etc.) and can be one processor or a plurality of processors that are operatively connected. Memory 52 can include one or more non-transitory computer-readable storage media, such as HBM, RAM, ROM, EEPROM, EPROM, flash memory devices, magnetic disks, etc., and combinations thereof. Memory 52 can store data 53 and instructions 54 which can be executed by processor(s) 51 to cause computing device 50 to perform operations. The operations can implement any one or multiple features described herein. The operations can implement example methods and techniques described herein.

Computing device 50 can also include one or more input components that receive user input. For example, a user input component can be a touch-sensitive component (e.g., a touch-sensitive display screen or a touch pad) that is sensitive to the touch of a user input object (e.g., a finger or a stylus). The touch-sensitive component can serve to implement a virtual keyboard. Other example user input components include a microphone, camera, LIDAR, a physical keyboard or other buttons, or other means by which a user can provide user input.

Computing device 50 can store or include one or more machine-learned models 55. Machine-learned models 55 can include one or more machine-learned model(s) 1, such as a sequence processing model 4. Machine-learned models 55 can include one or multiple model instance(s) 31-1. Machine-learned model(s) 55 can be received from server computing system(s) 60, model development platform system 70, third party system(s) 80 (e.g., an application distribution platform), or developed locally on computing device 50. Machine-learned model(s) 55 can be loaded into memory 52 and used or otherwise implemented by processor(s) 51. Computing device 50 can implement multiple parallel instances of machine-learned model(s) 55.

Server computing system(s) 60 can include one or more processors 61 and a memory 62. Processor(s) 61 can be any suitable processing device (e.g., a processor core, a microprocessor, an ASIC, an FPGA, a controller, a microcontroller, etc.) and can be one processor or a plurality of processors that are operatively connected. Memory 62 can include one or more non-transitory computer-readable storage media, such as HBM, RAM, ROM, EEPROM, EPROM, flash memory devices, magnetic disks, etc., and combinations thereof. Memory 62 can store data 63 and instructions 64 which can be executed by processor(s) 61 to cause server computing system(s) 60 to perform operations. The operations can implement any one or multiple features described herein. The operations can implement example methods and techniques described herein.

In some implementations, server computing system 60 includes or is otherwise implemented by one or multiple server computing devices. In instances in which server computing system 60 includes multiple server computing devices, such server computing devices can operate according to sequential computing architectures, parallel computing architectures, or some combination thereof.

Server computing system 60 can store or otherwise include one or more machine-learned models 65. Machine-learned model(s) 65 can be the same as or different from machine-learned model(s) 55. Machine-learned models 65 can include one or more machine-learned model(s) 1, such as a sequence processing model 4. Machine-learned models 65 can include one or multiple model instance(s) 31-1. Machine-learned model(s) 65 can be received from computing device 50, model development platform system 70, third party system(s) 80, or developed locally on server computing system(s) 60. Machine-learned model(s) 65 can be loaded into memory 62 and used or otherwise implemented by processor(s) 61. Server computing system(s) 60 can implement multiple parallel instances of machine-learned model(s) 65.

In an example configuration, machine-learned models 65 can be included in or otherwise stored and implemented by server computing system 60 to establish a client-server relationship with computing device 50 for serving model inferences. For instance, server computing system(s) 60 can implement model host 31 on behalf of client(s) 32 on computing device 50. For instance, machine-learned models 65 can be implemented by server computing system 60 as a portion of a web service (e.g., remote machine-learned model hosting service, such as an online interface for performing machine-learned model operations over a network on server computing system(s) 60). For instance, server computing system(s) 60 can communicate with computing device 50 over a local intranet or internet connection. For instance, computing device 50 can be a workstation or endpoint in communication with server computing system(s) 60, with implementation of machine-learned models 65 being managed by server computing system(s) 60 to remotely perform inference (e.g., for runtime or training operations), with output(s) returned (e.g., cast, streamed, etc.) to computing device 50. Machine-learned models 65 can work cooperatively or interoperatively with machine-learned models 55 on computing device 50 to perform various tasks.

Model development platform system(s) 70 can include one or more processors 71 and a memory 72. Processor(s) 71 can be any suitable processing device (e.g., a processor core, a microprocessor, an ASIC, an FPGA, a controller, a microcontroller, etc.) and can be one processor or a plurality of processors that are operatively connected. Memory 72 can include one or more non-transitory computer-readable storage media, such as HBM, RAM, ROM, EEPROM, EPROM, flash memory devices, magnetic disks, etc., and combinations thereof. Memory 72 can store data 73 and instructions 74 which can be executed by processor(s) 71 to cause model development platform system(s) 70 to perform operations. The operations can implement any one or multiple features described herein. The operations can implement example methods and techniques described herein. Example operations include the functionality described herein with respect to model development platform 12. This and other functionality can be implemented by developer tool(s) 75.

Third-party system(s) 80 can include one or more processors 81 and a memory 82. Processor(s) 81 can be any suitable processing device (e.g., a processor core, a microprocessor, an ASIC, an FPGA, a controller, a microcontroller, etc.) and can be one processor or a plurality of processors that are operatively connected. Memory 82 can include one or more non-transitory computer-readable storage media, such as HBM, RAM, ROM, EEPROM, EPROM, flash memory devices, magnetic disks, etc., and combinations thereof. Memory 82 can store data 83 and instructions 84 which can be executed by processor(s) 81 to cause third-party system(s) 80 to perform operations. The operations can implement any one or multiple features described herein. The operations can implement example methods and techniques described herein. Example operations include the functionality described herein with respect to tools and other external resources called when training or performing inference with machine-learned model(s) 1, 4, 16, 20, 55, 65, etc. (e.g., third-party resource(s) 85).

FIG. 13 illustrates one example arrangement of computing systems that can be used to implement the present disclosure. Other computing system configurations can be used as well. For example, in some implementations, one or both of computing system 50 or server computing system(s) 60 can implement all or a portion of the operations of model development platform system 70. For example, computing system 50 or server computing system(s) 60 can implement developer tool(s) 75 (or extensions thereof) to develop, update/train, or refine machine-learned models 1, 4, 16, 20, 55, 65, etc. using one or more techniques described herein with respect to model alignment toolkit 17. In this manner, for instance, computing system 50 or server computing system(s) 60 can develop, update/train, or refine machine-learned models based on local datasets (e.g., for model personalization/customization, as permitted by user data preference selections).

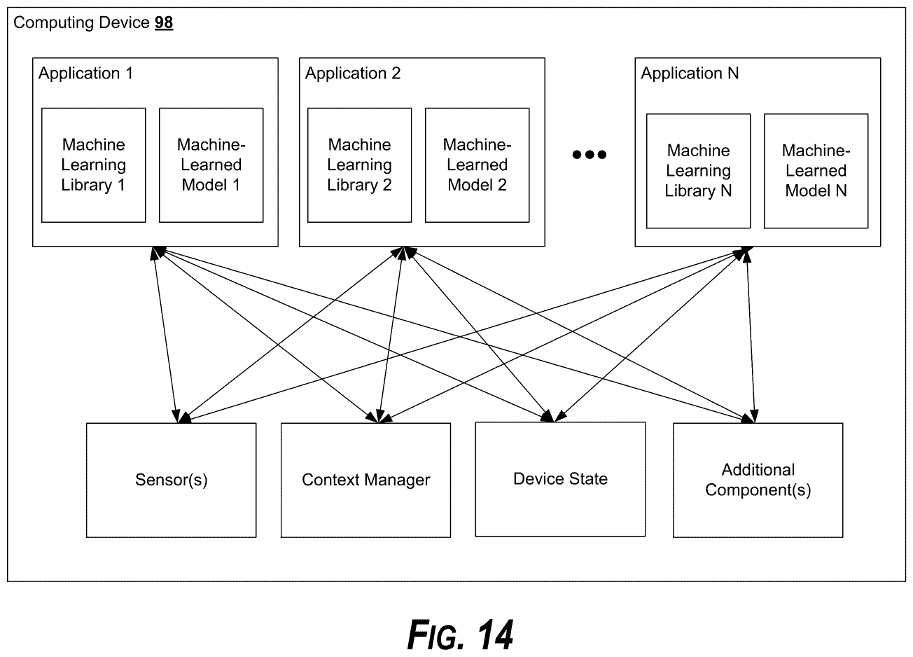

FIG. 14 is a block diagram of an example computing device 98 that performs according to example embodiments of the present disclosure. Computing device 98 can be a user computing device or a server computing device (e.g., computing device 50, server computing system(s) 60, etc.). Computing device 98 can implement model host 31. For instance, computing device 98 can include a number of applications (e.g., applications 1 through N). Each application can contain its own machine learning library and machine-learned model(s). For example, each application can include a machine-learned model. Example applications include a text messaging application, an email application, a dictation application, a virtual keyboard application, a browser application, etc. As illustrated in FIG. 14, each application can communicate with a number of other components of the computing device, such as, for example, one or more sensors, a context manager, a device state component, or additional components. In some implementations, each application can communicate with each device component using an API (e.g., a public API). In some implementations, the API used by each application is specific to that application.

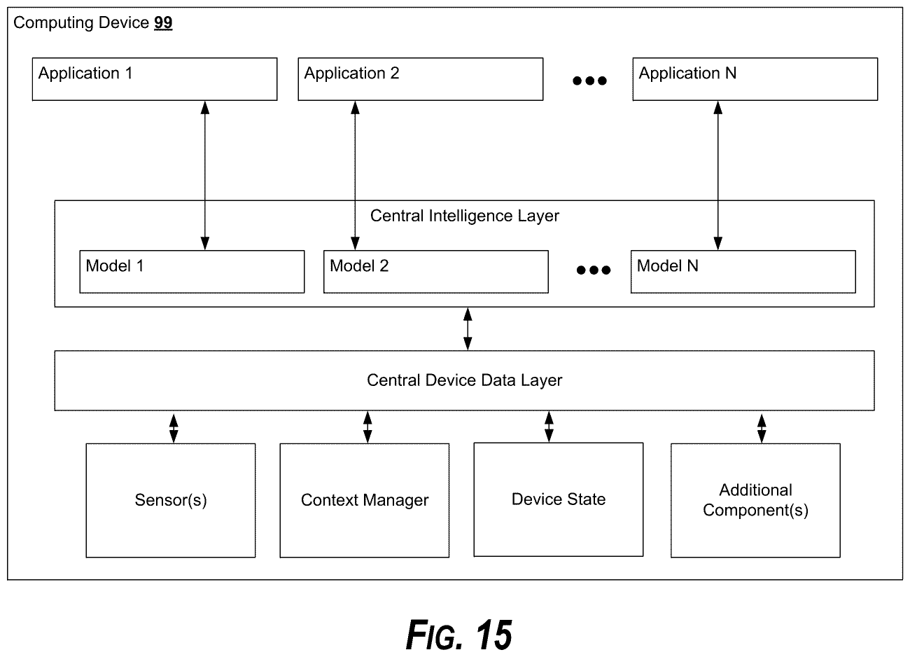

FIG. 15 is a block diagram of an example computing device 99 that performs according to example embodiments of the present disclosure. Computing device 99 can be the same as or different from computing device 98. Computing device 99 can be a user computing device or a server computing device (e.g., computing device 50, server computing system(s) 60, etc.). Computing device 98 can implement model host 31. For instance, computing device 99 can include a number of applications (e.g., applications 1 through N). Each application can be in communication with a central intelligence layer. Example applications include a text messaging application, an email application, a dictation application, a virtual keyboard application, a browser application, etc. In some implementations, each application can communicate with the central intelligence layer (and model(s) stored therein) using an API (e.g., a common API across all applications).

The central intelligence layer can include a number of machine-learned models. For example, as illustrated in FIG. 15, a respective machine-learned model can be provided for each application and managed by the central intelligence layer. In other implementations, two or more applications can share a single machine-learned model. For example, in some implementations, the central intelligence layer can provide a single model for all of the applications. In some implementations, the central intelligence layer is included within or otherwise implemented by an operating system of computing device 99.

The central intelligence layer can communicate with a central device data layer. The central device data layer can be a centralized repository of data for computing device 99. As illustrated in FIG. 15, the central device data layer can communicate with a number of other components of the computing device, such as, for example, one or more sensors, a context manager, a device state component, or additional components. In some implementations, the central device data layer can communicate with each device component using an API (e.g., a private API).

### Additional Disclosure

The technology discussed herein makes reference to servers, databases, software applications, and other computer-based systems, as well as actions taken and information sent to and from such systems. The inherent flexibility of computer-based systems allows for a great variety of possible configurations, combinations, and divisions of tasks and functionality between and among components. For instance, processes discussed herein can be implemented using a single device or component or multiple devices or components working in combination. Databases and applications can be implemented on a single system or distributed across multiple systems. Distributed components can operate sequentially or in parallel.

While the present subject matter has been described in detail with respect to various specific example embodiments thereof, each example is provided by way of explanation, not limitation of the disclosure. Those skilled in the art, upon attaining an understanding of the foregoing, can readily produce alterations to, variations of, and equivalents to such embodiments. Accordingly, the subject disclosure does not preclude inclusion of such modifications, variations or additions to the present subject matter as would be readily apparent to one of ordinary skill in the art. For instance, features illustrated or described as part of one embodiment can be used with another embodiment to yield a still further embodiment. Thus, it is intended that the present disclosure cover such alterations, variations, and equivalents.

Aspects of the disclosure have been described in terms of illustrative embodiments thereof. Any and all features in the following claims can be combined or rearranged in any way possible, including combinations of claims not explicitly enumerated in combination together, as the example claim dependencies listed herein should not be read as limiting the scope of possible combinations of features disclosed herein. Accordingly, the scope of the present disclosure is by way of example rather than by way of limitation, and the subject disclosure does not preclude inclusion of such modifications, variations or additions to the present subject matter as would be readily apparent to one of ordinary skill in the art. Moreover, terms are described herein using lists of example elements joined by conjunctions such as “and,” “or,” “but,” etc. It should be understood that such conjunctions are provided for explanatory purposes only. Clauses and other sequences of items joined by a particular conjunction such as “or,” for example, can refer to “and/or,” “at least one of”, “any combination of” example elements listed therein, etc. Terms such as “based on” should be understood as “based at least in part on.”

The term “can” should be understood as referring to a possibility of a feature in various implementations and not as prescribing an ability that is necessarily present in every implementation. For example, the phrase “X can perform Y” should be understood as indicating that, in various implementations, X has the potential to be configured to perform Y, and not as indicating that in every instance X must always be able to perform Y. It should be understood that, in various implementations, X might be unable to perform Y and remain within the scope of the present disclosure.

The term “may” should be understood as referring to a possibility of a feature in various implementations and not as prescribing an ability that is necessarily present in every implementation. For example, the phrase “X may perform Y” should be understood as indicating that, in various implementations, X has the potential to be configured to perform Y, and not as indicating that in every instance X must always be able to perform Y. It should be understood that, in various implementations, X might be unable to perform Y and remain within the scope of the present disclosure.

1. A computer-implemented method for efficiently generating multimodal sequenced outputs using a multiscale machine-learned architecture, comprising:
generating, using a first machine-learned sequence processing model, a first frame token associated with a first frame;
generating, using a second machine-learned sequence processing model and based on the first frame token, a first frame-aligned token associated with the first frame and characterized by a first mode; and
generating, using at least one of the second machine-learned sequence processing model and a third machine-learned sequence processing model, and based on at least one of the first frame token and the first frame-aligned token, a second frame-aligned token associated with the first frame and characterized by a second mode, wherein the second mode is different from the first mode, and wherein at least one of the first frame-aligned token and the second frame-aligned token is a residual vector quantization token.

2. The method of claim 1, wherein the second mode is an audio mode.

3. The method of claim 1, wherein a number of parameters of the second machine-learned sequence processing model is smaller than a number of parameters of the first machine-learned sequence processing model.

4. The method of claim 1, wherein the second mode is a text mode.

5. The method of claim 1, wherein the first mode is a semantic mode.

6. The method of claim 1, further comprising:
generating, using the second machine-learned sequence processing model and based on the second frame-aligned token, a third frame-aligned token associated with the first frame and characterized by the second mode; and
generating, based on the second frame-aligned token and the third frame-aligned token, an output frame associated with the first frame and characterized by the second first mode.

7. The method of claim 6, wherein generating an output frame comprises combining the second frame-aligned token and the third frame-aligned token.

8. The method of claim 7, wherein the third frame-aligned token is a residual vector quantization token associated with a residual of the second frame-aligned token.

9. The method of claim 6, further comprising:
generating, using a fourth machine-learned model, one or more additional frame-aligned tokens, wherein:
generating the additional frame-aligned tokens comprises discrete diffusion; and
generating an output frame comprises combining the first frame-aligned token, the third frame-aligned token, and the additional frame-aligned tokens.

10. The method of claim 1, further comprising:
determining, based on at least one of the first frame-aligned token and the second frame-aligned token, an input frame token associated with the first frame; and
generating, based on the input frame token, a second frame token associated with a second frame.

11. The method of claim 10, wherein determining an input frame token comprises average pooling.

12. The method of claim 10, wherein determining an input frame token comprises machine-learned embedding of one or more frame-aligned tokens.

13. The method of claim 1, wherein the first frame token is also associated with a second frame, and further comprising:
generating a fourth frame-aligned token associated with the second frame, based on at least one of the first frame token, the first frame-aligned token, and the second frame-aligned token.

14. The method of claim 1, wherein the first frame is a time frame.

15. The method of claim 1, wherein generating the first frame token comprises autoregressive generation.

16. The method of claim 1, wherein generating the first frame-aligned token comprises autoregressive generation.

17. The method of claim 1, wherein at least one of the first machine-learned sequence processing model and the second machine-learned sequence processing model is a transformer.

18. The method of claim 1, wherein the second machine-learned sequence processing model is a multilayer perceptron.

19. A computing system comprising one or more processors and one or more non-transitory computer-readable media storing instructions that are executable by the one or more processors to cause the computing system to perform one or more operations, the operations comprising:
generating, using a first machine-learned sequence processing model, a first frame token associated with a first frame;
generating, using a second machine-learned sequence processing model and based on the first frame token, a first frame-aligned token associated with the first frame and characterized by a first mode; and
generating, using at least one of the second machine-learned sequence processing model and a third machine-learned sequence processing model, and based on the first frame token, a second frame-aligned token associated with the first frame and characterized by a second mode, wherein the second mode is different from the first mode, and wherein at least one of the first frame-aligned token and the second frame-aligned token is a residual vector quantization token.

20. One or more non-transitory computer-readable media storing instructions that are executable by one or more computing systems to perform one or more operations, the operations comprising:
generating, using a first machine-learned sequence processing model, a first frame token associated with a first frame;
generating, using a second machine-learned sequence processing model and based on the first frame token, a first frame-aligned token associated with the first frame and characterized by a first mode; and
generating, using at least one of the second machine-learned sequence processing model and a third machine-learned sequence processing model, and based on the first frame token, a second frame-aligned token associated with the first frame and characterized by a second mode, wherein the second mode is different from the first mode, and wherein at least one of the first frame-aligned token and the second frame-aligned token is a residual vector quantization token.

21. The method of claim 1, wherein the first mode is a semantic mode and the second mode is an acoustic mode.

22. The method of claim 1, wherein the first mode is an acoustic mode and the second mode is a text mode.

23. The method of claim 1, wherein the first frame-aligned token is a multimodal token and the second mode is an acoustic mode.
